(19) United States
(12) Patent Application Publication
(10) Pub. No.: US 2025/0105982 A1
(43) Pub. Date: Mar. 27, 2025

(54) TECHNIQUES FOR SIDELINK RETRANSMISSION OF AN ACCESS LINK TRANSPORT BLOCK

(71) Applicant: QUALCOMM Incorporated, San Diego, CA (US)

(72) Inventors: Zhichao ZHOU, Beijing (CN); Seyedkianoush HOSSEINI, San Diego, CA (US)

(21) Appl. No.: 18/832,361

(22) PCT Filed: Mar. 24, 2022
(86) PCT No.: PCT/CN2022/082668

§ 371 Date: Jul. 23, 2024

(51) Int. Cl. H04L 5/00; H04W 72/11; H04W 72/232; H04W 72/40

(52) U.S. Cl. CPC H04L 5/0055; H04W 72/11; H04W 72/40; H04W 72/232

(57) ABSTRACT

Various aspects of the present disclosure generally relate to wireless communication. In some aspects, a user equipment (UE) may transmit, to another UE via a sidelink, a feedback communication associated with a transport block in a physical downlink shared channel (PDSCH), wherein the feedback communication is transmitted via a sidelink feedback channel that is associated with the PDSCH. The UE may receive, from the other UE, a retransmission of the transport block based at least in part on the feedback communication being transmitted in the sidelink feedback channel that is associated with the PDSCH. Numerous other aspects are described.

### FIELD OF THE DISCLOSURE

Aspects of the present disclosure generally relate to wireless communication and to techniques and apparatuses for sidelink retransmission of an access link transport block.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, to another UE via a sidelink, a feedback communication associated with a transport block in a physical downlink shared channel (PDSCH), where the feedback communication is transmitted via a sidelink feedback channel that is associated with the PDSCH. The method may include receiving, from the other UE, a retransmission of the transport block based at least in part on the feedback communication being transmitted in the sidelink feedback channel that is associated with the PDSCH.

Some aspects described herein relate to a method of wireless communication performed by a UE. The method may include receiving, from another UE via a sidelink, a feedback communication associated with a transport block in a PDSCH, where the feedback communication is transmitted via a sidelink feedback channel that is associated with the PDSCH. The method may include transmitting, to the other UE, a retransmission of the transport block based at least in part on receiving the feedback communication in the sidelink feedback channel that is associated with the PDSCH.

Some aspects described herein relate to a method of wireless communication performed by a network entity. The method may include transmitting, to a group of UEs, a transport block in a PDSCH. The method may include transmitting, to the group of UEs, a configuration associating a sidelink feedback channel with the PDSCH.

Some aspects described herein relate to an apparatus for wireless communication at a UE. The apparatus may include a memory and one or more processors coupled to the memory. The one or more processors may be configured to transmit, to another UE via a sidelink, a feedback communication associated with a transport block in a PDSCH. The one or more processors may be configured to receive, from the other UE, a retransmission of the transport block based at least in part on the feedback communication being transmitted in the sidelink feedback channel that is associated with the PDSCH.

Some aspects described herein relate to an apparatus for wireless communication at a UE. The apparatus may include a memory and one or more processors coupled to the memory. The one or more processors may be configured to receive, from another UE via a sidelink, a feedback communication associated with a transport block in a PDSCH. The one or more processors may be configured to transmit, to the other UE, a retransmission of the transport block based at least in part on receiving the feedback communication in the sidelink feedback channel that is associated with the PDSCH.

Some aspects described herein relate to an apparatus for wireless communication at a network entity. The apparatus may include a memory and one or more processors coupled to the memory. The one or more processors may be configured to transmit, to a group of UEs, a transport block in a PDSCH. The one or more processors may be configured to transmit, to the group of UEs, a configuration associating a sidelink feedback channel with the PDSCH.

Some aspects described herein relate to a non-transitory computer-readable medium that stores a set of instructions for wireless communication by a UE. The set of instructions, when executed by one or more processors of the UE, may cause the UE to transmit, to another UE via a sidelink, a feedback communication associated with a transport block in PDSCH. The set of instructions, when executed by one or more processors of the UE, may cause the UE to receive, from the other UE, a retransmission of the transport block based at least in part on the feedback communication being transmitted in the sidelink feedback channel that is associated with the PDSCH.

Some aspects described herein relate to a non-transitory computer-readable medium that stores a set of instructions for wireless communication by a UE. The set of instructions, when executed by one or more processors of the UE, may cause the UE to receive, from another UE via a sidelink, a feedback communication associated with a transport block in a PDSCH. The set of instructions, when executed by one or more processors of the UE, may cause the UE to transmit, to the other UE, a retransmission of the transport block based at least in part on receiving the feedback communication in the sidelink feedback channel that is associated with the PDSCH.

Some aspects described herein relate to a non-transitory computer-readable medium that stores a set of instructions for wireless communication by a network entity. The set of instructions, when executed by one or more processors of the network entity, may cause the network entity to transmit, to a group of UEs, a transport block in a PDSCH. The set of instructions, when executed by one or more processors of the network entity, may cause the network entity to transmit, to the group of UEs, a configuration associating a sidelink feedback channel with the PDSCH.

Some aspects described herein relate to an apparatus for wireless communication. The apparatus may include means for transmitting, to a UE via a sidelink, a feedback communication associated with a transport block in a PDSCH, where the feedback communication is transmitted via a sidelink feedback channel that is associated with the PDSCH. The apparatus may include means for receiving, from the UE, a retransmission of the transport block based at least in part on the feedback communication being transmitted in the sidelink feedback channel that is associated with the PDSCH.

Some aspects described herein relate to an apparatus for wireless communication. The apparatus may include means for receiving, from a UE via a sidelink, a feedback communication associated with a transport block in a PDSCH, where the feedback communication is transmitted via a sidelink feedback channel that is associated with the PDSCH. The apparatus may include means for transmitting, to the UE, a retransmission of the transport block based at least in part on receiving the feedback communication in the sidelink feedback channel that is associated with the PDSCH.

Some aspects described herein relate to an apparatus for wireless communication. The apparatus may include means for transmitting, to a group of UEs, a transport block in a PDSCH. The apparatus may include means for transmitting, to the group of UEs, a configuration associating a sidelink feedback channel with the PDSCH.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example associated with sidelink retransmission of an access link transport block, in accordance with the present disclosure.

FIG. 7 is a diagram illustrating an example associated with semi-persistently scheduled sidelink feedback channel resources, in accordance with the present disclosure.

FIG. 8 is a diagram illustrating an example associated with a sidelink feedback channel resource pool, in accordance with the present disclosure.

FIG. 9 is a diagram illustrating an example associated with resource allocation for a sidelink feedback channel, in accordance with the present disclosure.

FIG. 10 is a diagram illustrating an example associated with resource allocation for a sidelink feedback channel, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram illustrating an example process performed, for example, by a network entity, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

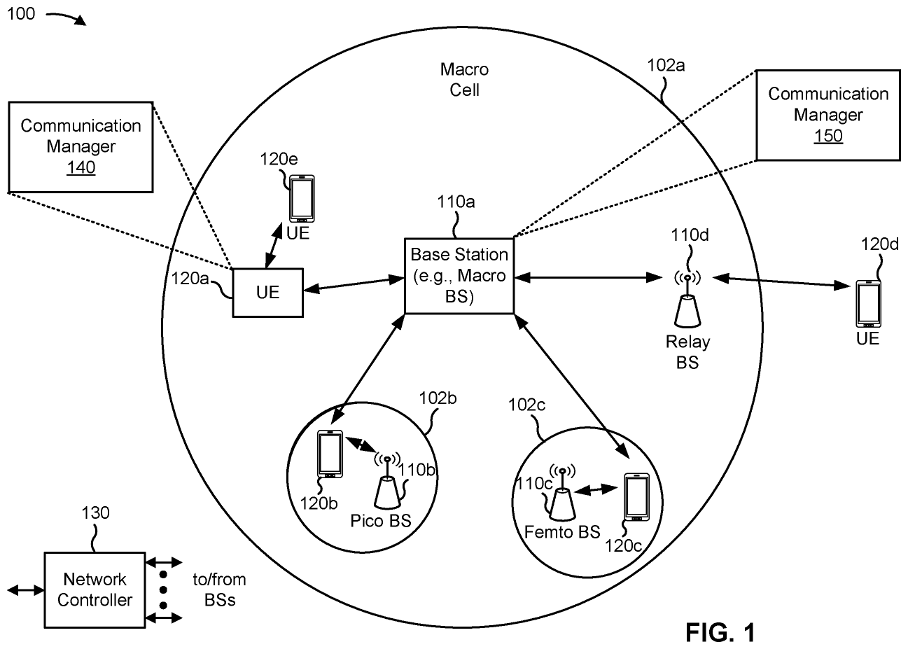

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to another UE via a sidelink, a feedback communication associated with a transport block in a physical downlink shared channel (PDSCH), wherein the feedback communication is transmitted via a sidelink feedback channel that is associated with the PDSCH; and receive, from the other UE, a retransmission of the transport block based at least in part on the feedback communication being transmitted in the sidelink feedback channel that is associated with the PDSCH.

In some aspects, the communication manager 140 may receive, from another UE via a sidelink, a feedback communication associated with a transport block in a PDSCH, wherein the feedback communication is transmitted via a sidelink feedback channel that is associated with the PDSCH; and transmit, to the other UE, a retransmission of the transport block based at least in part on receiving the feedback communication in the sidelink feedback channel that is associated with the PDSCH. Additionally, or alternatively, the communication manager 140 may perform one or more other operations described herein.

In some aspects, the base station may include a communication manager 150. As described in more detail elsewhere herein, the communication manager 150 may transmit, to a group of UEs, a transport block in a PDSCH; and transmit, to the group of UEs, a configuration associating a sidelink feedback channel with the PDSCH. Additionally, or alternatively, the communication manager 150 may perform one or more other operations described herein.

As indicated above, FIG. 1 is provided as an example. Other examples may differ from what is described with regard to FIG. 1.

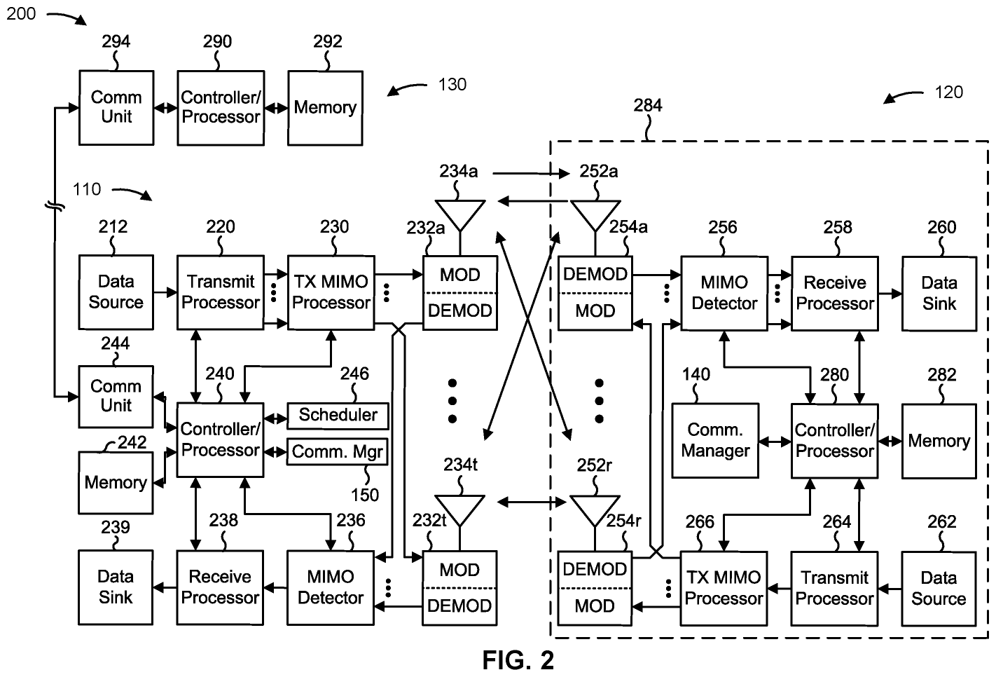

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

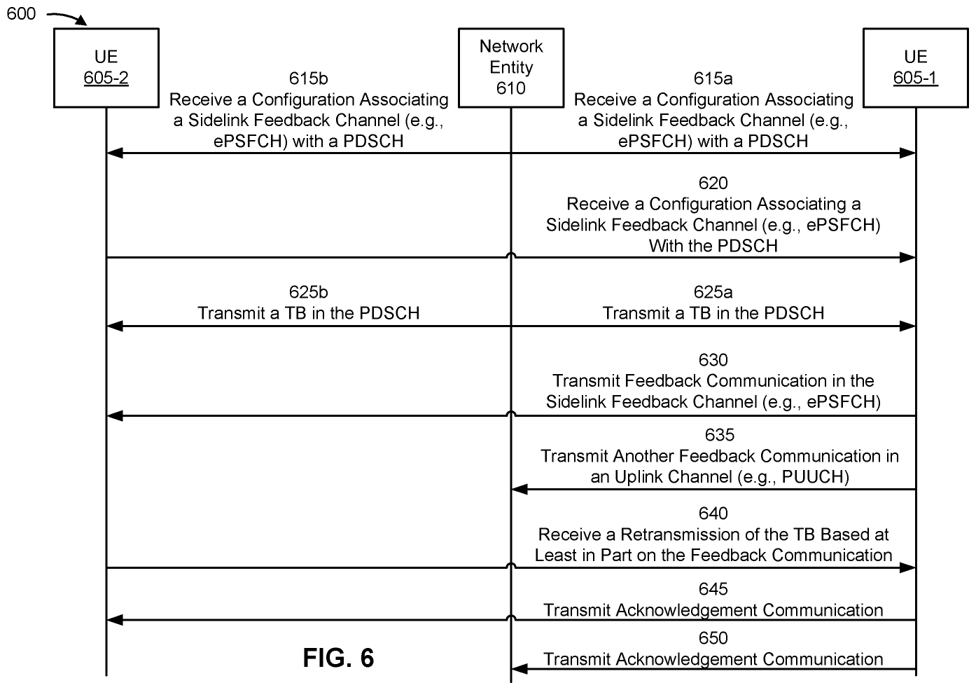

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-16).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-16).

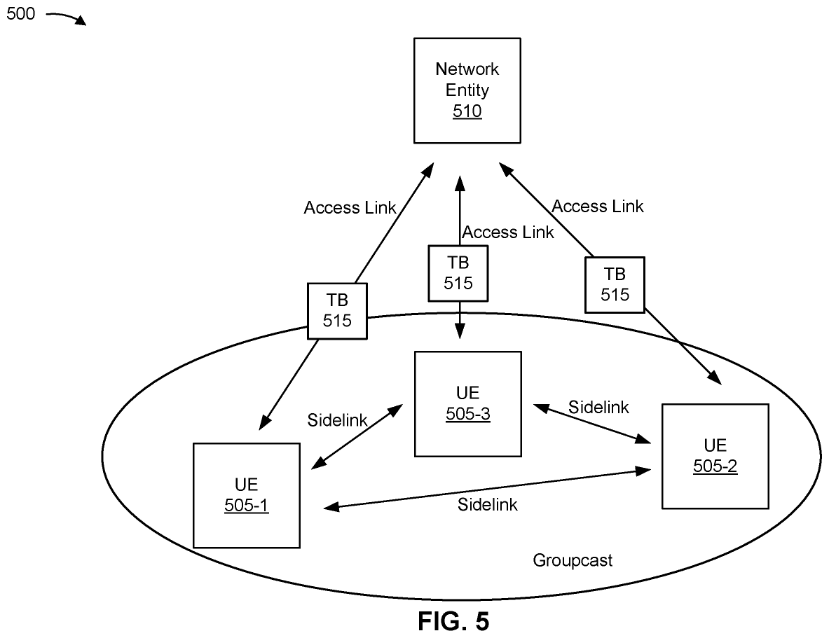

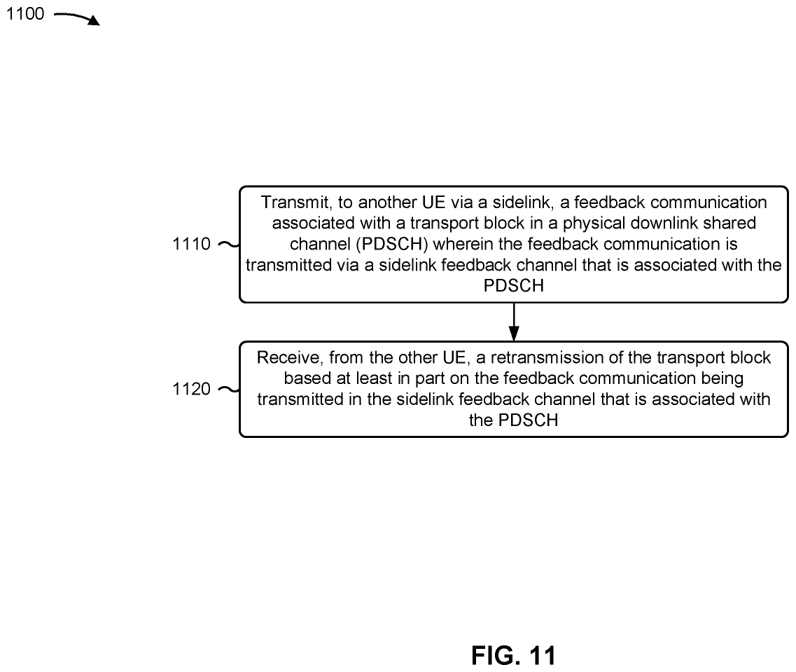

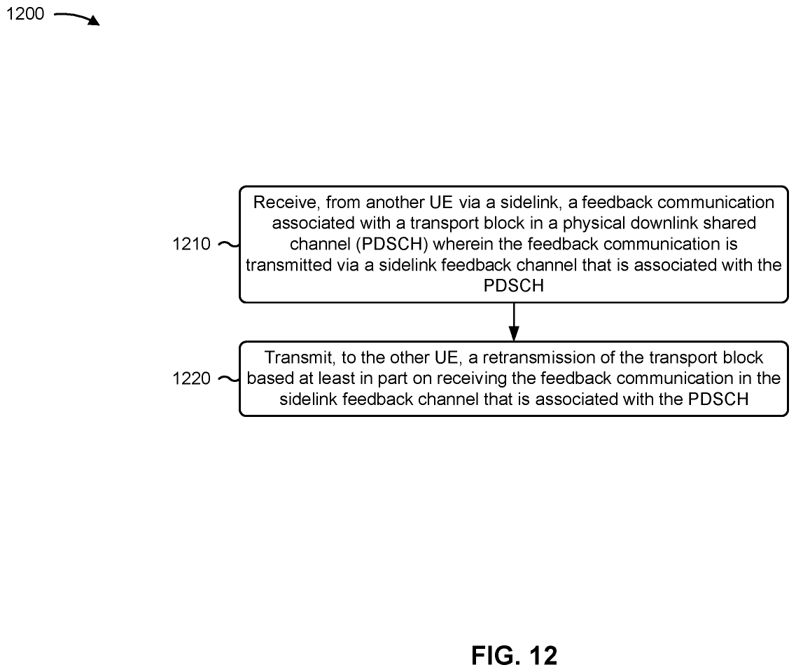

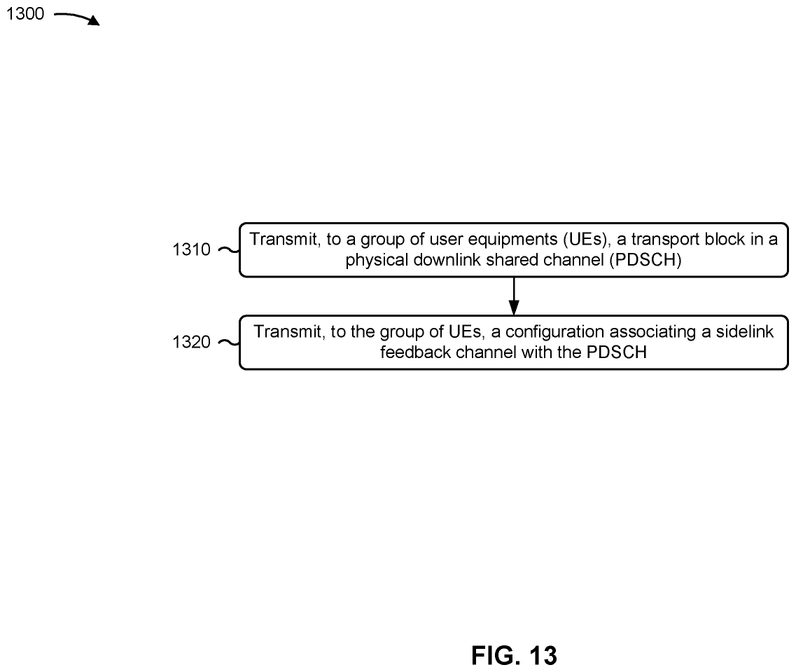

The controller/processor 240 of the base station 110, the controller/processor 280 of the UE 120, and/or any other component(s) of FIG. 2 may perform one or more techniques associated with sidelink retransmission of an access link transport block, as described in more detail elsewhere herein. In some aspects, a network entity (e.g., a network entity 510 described below in connection with FIG. 5 and/or a network entity 610 described below in connection with FIG. 6) described herein is the base station 110, is included in the base station 110, or includes one or more components of the base station 110 shown in FIG. 2. The controller/processor 240 of the base station 110, the controller/processor 280 of the UE 120, and/or any other component(s) of FIG. 2 may perform or direct operations of, for example, process 1100 of FIG. 11, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for transmitting, to another UE via a sidelink, a feedback communication associated with a transport block in a PDSCH, wherein the feedback communication is transmitted via a sidelink feedback channel that is associated with the PDSCH; and/or means for receiving, from the other UE, a retransmission of the transport block based at least in part on the feedback communication being transmitted in the sidelink feedback channel that is associated with the PDSCH. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving, from another UE via a sidelink, a feedback communication associated with a transport block in a PDSCH, wherein the feedback communication is transmitted via a sidelink feedback channel that is associated with the PDSCH; and/or means for transmitting, to the other UE, a retransmission of the transport block based at least in part on receiving the feedback communication in the sidelink feedback channel that is associated with the PDSCH. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity described herein (e.g., the network entity 510 described below in connection with FIG. 5, the network entity 610 described in connection with FIG. 6, the base station 110, or a similar network entity) includes means for transmitting, to a group of UEs, a transport block in a PDSCH; and/or means for transmitting, to the group of UEs, a configuration associating a sidelink feedback channel with the PDSCH. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

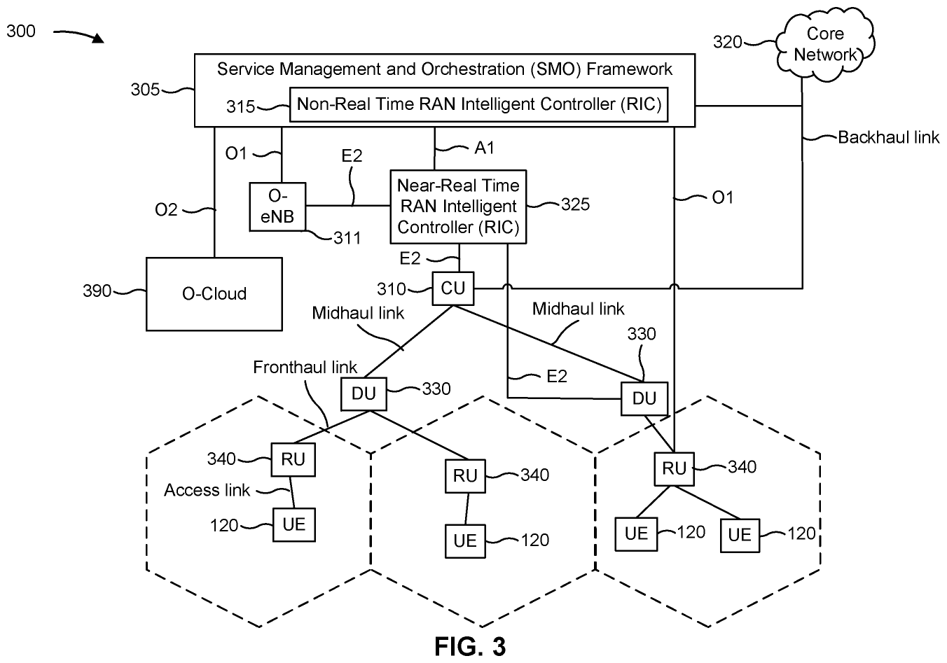

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU). “Network entity” or “network node” can refer to a disaggregated base station, or to one or more units of a disaggregated base station (such as one or more CUs, one or more DUs, one or more RUs, or a combination thereof). “Network entity” or “network node” can refer to a disaggregated base station, or to one or more units of a disaggregated base station (such as one or more CUs, one or more DUs, one or more RUs, or a combination thereof).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

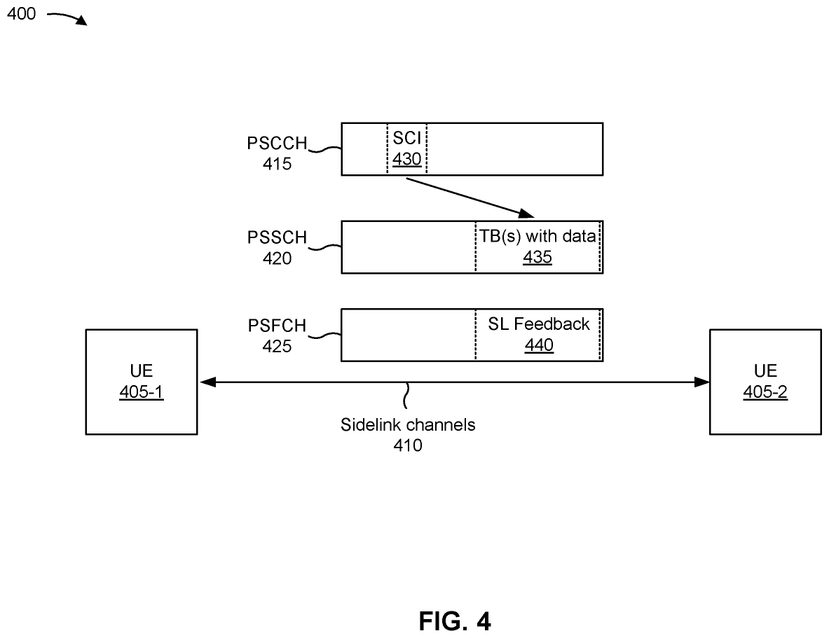

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel. The PSSCH 420 may be used to communicate data, similar to a PDSCH and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a base station 110 or other network entity. For example, the UE 405 may receive a grant (e.g., in downlink control information (DCI) or in an RRC message, such as for configured grants) from the base station 110 for sidelink channel access and/or scheduling. In some aspects, a UE 405 may operate using a transmission mode (e.g., Mode 2) where resource selection and/or scheduling is performed by the UE 405 (e.g., rather than a base station 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

FIG. 5 is a diagram illustrating an example 500 of sidelink communications and access link communications, in accordance with the present disclosure.

As shown in FIG. 5, a first UE 505-1, a second UE 505-2, and a third UE 505-3 may communicate with one another via a sidelink, as described above in connection with FIG. 4. As further shown, in some sidelink modes, a network entity 510 (e.g., a base station 110, a CU 310, a DU 330, an RU 340, or a similar network entity) may communicate with the first UE 505-1, the second UE 505-2, and the third UE 505-3 via respective access links. The UEs 505-1, 505-2, 505-3 may correspond to one or more UEs described elsewhere herein, such as the UE 120 of FIG. 1 or the UEs 405-1, 405-2 of FIG. 4. Thus, a direct link between UEs 120 (e.g., via a PC5 interface) may be referred to as a sidelink, and a direct link between a base station 110 or other network entity and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

In some aspects, the UEs 505 and the network entity 510 may be operating in a groupcast mode, with the UEs 505 forming part of a group and with each UE 505 receiving the same downlink traffic from the network entity 510. For example, in FIG. 5, each UE 505 receives the same TB 515 from the network entity via respective access links. In some aspects, the UEs 505 forming a group may be head mounted displays (HMDs) that receive the same video stream, may be UEs involved in the same cloud gaming environment, or may be similar UEs that receive the same downlink traffic. In such aspects, high reliability and/or low power consumption may be desirable for seamless operation of the groupcast experience. Thus, retransmission may be used in such scenarios in order to ensure high reliability groupcast transmissions. More particularly, if one UE 505 of the group of UEs 505 does not successfully decode a TB (e.g., TB 515), the TB should be quickly and efficiently retransmitted such that the shared experience among the group of UEs 505 remains sufficiently uninterrupted.

However, retransmissions to one or more UEs 505 from the network entity 510 over the access link may be slow as compared to communications between neighboring UEs 505 over the sidelink (e.g., retransmissions to one or more UEs 505 from the network entity 510 over the access link may be associated with a high latency as compared to communications between two UEs 505 over the sidelink) because the network entity 510 may be located farther from the UEs 505 than the UEs 505 are located from one another. Similarly, retransmissions to one or more UEs 505 from the network entity 510 may result in higher power consumption than communications between neighboring UEs 505, because the UE 505 may transmit the NACK communication to the network entity 510, and the network entity 510 may in turn retransmit the TB 515 back to the UE 505, over a distance farther than a distance between neighboring UEs 505. Furthermore, providing a feedback communication (e.g., a NACK communication) on the access link and receiving a retransmission on the access link consumes access link resources and leads to reduced capacity, which may be particularly problematic in groupcast scenarios involving a large number of UEs 505.

Some techniques and apparatuses described herein allow a UE to communicate feedback, associated with a TB in a PDSCH, via a sidelink feedback channel associated with the PDSCH to enable improved retransmissions among UEs. In this way, a retransmission of the TB may be received by a UE from another UE rather than from the BS. As a result, latency may be reduced because the UEs may be located nearer to one another than the BS, power consumption may be reduced because the feedback communication and/or retransmission of the TB may be accomplished over a shorter distance than the distance between a UE and the BS, access link capacity may be increased because fewer retransmissions need to be carried out over the access link than if the BS transmitted the retransmissions to the UE, and/or sidelink capacity or access link capacity may be improved by relying on an association between a sidelink feedback channel and a PDSCH as a basis for communicating a retransmission rather than relying on more or different signaling to identify the TB to be retransmitted.

As indicated above, FIG. 5 is provided as an example. Other examples may differ from what is described with respect to FIG. 5.

FIG. 6 is a diagram illustrating an example 600 associated with sidelink retransmission of an access link TB, in accordance with the present disclosure. As shown in FIG. 6, a first UE 605-1, a second UE 605-2, and a network entity 610 may communicate with one another. The first UE 605-1 and the second UE 605-1 may correspond to any of the UEs described herein, such as the UE 120, one of the UEs 405-1, 405-2 described in connection with FIG. 4, and/or one of the UEs 505-1, 505-2, 505-3 described in connection with FIG. 5. The network entity 610 may correspond to any of the network entities described herein, such as the base station 110, the CU 310, the DU 330, the RU 340, and/or the network entity 510 described in connection with FIG. 5. In that regard, each UE 605-1, 605-2 may communicate with the network entity 610 via the access link (e.g., via the Uu interface), and each UE 605-1, 605-2 may communicate with each other via the sidelink (e.g., via the PC5 interface).

As shown by reference numbers 615a and 615b, the first UE 605-1 and/or the second UE 605-2 may receive, from the network entity 610, a configuration associating a sidelink feedback channel with a PDSCH. In some aspects, the first UE 605-1 and the second UE 605-2 may form part of a group of UEs associated with a groupcast communication, such as the group of UEs 505-1, 505-2, 505-3 described in connection with FIG. 5. Thus, in such aspects, the configuration shown by reference numbers 615a and 615b may be transmitted to the first UE 605-1 (as shown by reference number 615a) and to the second UE 605-2 (as shown by reference number 615b) via a groupcast message or the like. Additionally, or alternatively, the configuration shown at reference numbers 615a and 615b may be transmitted to the first UE 605-1 and/or the second UE 605-2 using an RRC message, a DCI message, a medium access control (MAC) control element (MAC-CE) message, or a similar message.

In some other aspects, and as shown by reference number 620, instead of, or in addition to, receiving the configuration from the network entity 610, one of the UEs 605 may receive the configuration associating the sidelink feedback channel with the PDSCH from another UE 605. For example, when the first UE 605-1 and the second UE 605-2 form a part of a group of UEs associated with a groupcast communication (e.g., the group of UEs 505-1, 505-2, 505-3 described in connection with FIG. 5), one of the UEs of the group of UEs (sometimes referred to as a head UE, or UEₕ) may transmit the configuration associating the sidelink feedback channel with the PDSCH to the other UEs of the group of UEs. In such aspects, the configuration associating the sidelink feedback channel with the PDSCH may be transmitted to the group of UEs using an SCI message (e.g., an SCI-1 message and/or an SCI-2 message) or the like, such as the SCI 430 described in connection with FIG. 4. In the example shown in FIG. 6, the second UE 605-2 serves as the head UE, and thus the first UE 605-1 may receive, from the second UE 605-2, the configuration associating the sidelink feedback channel with the PDSCH. Aspects of the disclosure are not so limited, however, and, in some other aspects, another UE (e.g., the first UE 605-1 or another UE not shown in FIG. 6) may serve as the head UE and thus transmit the configuration associating the sidelink feedback channel with the PDSCH to the other UEs in the group of UEs.

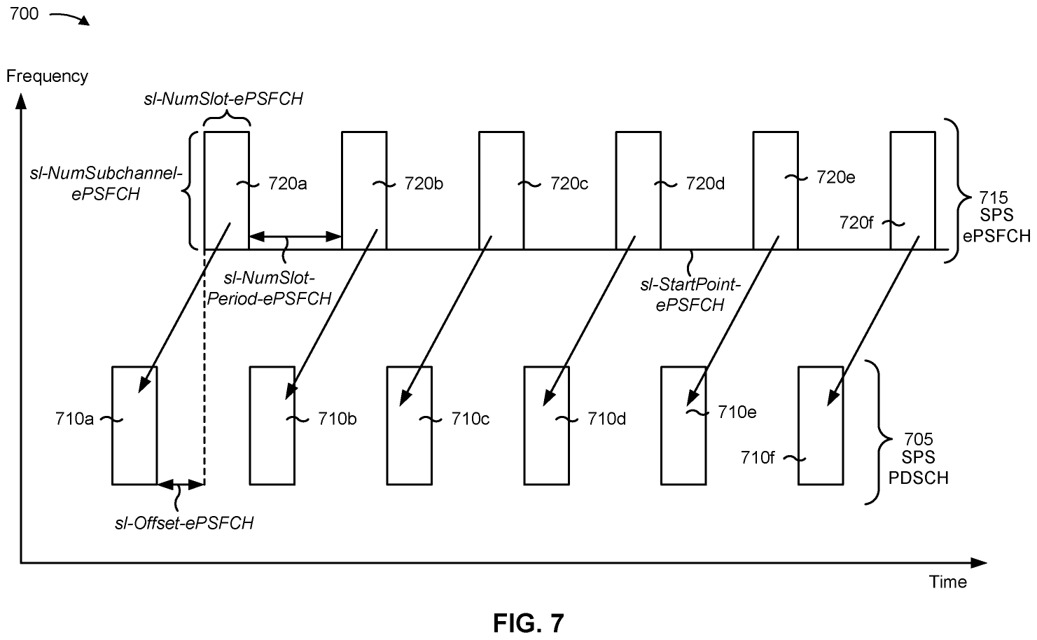

In some aspects, the sidelink feedback channel may be referred to as an enhanced PSFCH (ePSFCH), may be an ePSFCH, and/or may include an ePSFCH. Moreover, in some aspects, the sidelink feedback channel (e.g., the ePSFCH) may be separate from a traditional PSFCH, such as the PSFCH 425 described in connection with FIG. 4 (e.g., the sidelink feedback channel may be associated with a different set of resources than the PSFCH). As another example, the sidelink feedback channel (e.g., the ePSFCH) may be associated with the PDSCH whereas a traditional PSFCH is not associated with a PDSCH. By associating the sidelink feedback channel with the PDSCH, one of the first UE 605-1 or the second UE 605-2 may transmit a feedback communication (e.g., a NACK communication) in the sidelink feedback channel, and the other of the first UE 605-1 or the second UE 605-2 may associate the NACK communication with a TB of the PDSCH, and, accordingly, retransmit the TB in the sidelink (e.g., within the PSSCH 420). Aspects of certain configurations associating the sidelink feedback channel (e.g., the ePSFCH) with the PDSCH will be described in more detail in connection with FIGS. 7-10.

As shown by reference number 625a and 625b, the network entity 610 may transmit, in the PDSCH associated with the sidelink feedback channel, a TB (e.g., TB 515) to the first UE 605-1 (as shown by reference number 625a) and to the second UE 605-2 (as shown by reference number 625b). As described in connection with FIG. 5, when the first UE 605-1 and the second UE 605-2 form a part of a group of UEs associated with a groupcast communication (e.g., the group of UEs 505-1, 505-2, 505-3), the TB transmitted to each UE is the same TB, and thus, in the communication shown at reference number 625, the network entity 610 may transmit the same TB to the first UE 605-1 and the second UE 605-2. For example, in some aspects, the first UE 605-1 and the second UE 605-2 may each be an HMD receiving a same video stream, and/or the first UE 605-1 and the second UE 605-2 may be associated with the same cloud gaming environment receiving the same TB as part of the cloud gaming environment.

In some aspects, one of the first UE 605-1 or the second UE 605-2 may not properly decode the TB, and thus may initiate a retransmission of the TB using a feedback communication. More particularly, as shown by reference number 630, the first UE 605-1 may transmit, to the second UE 605-2 via the sidelink, a feedback communication associated with TB received in the PDSCH, wherein the feedback communication is transmitted via the sidelink feedback channel (e.g., the ePSFCH) that is associated with the PDSCH. More particularly, the feedback communication may be a communication associated with a HARQ process, such as a NACK communication, and the first UE 605-1 may transmit the feedback communication (e.g., the NACK communication) to the second UE 605-2 in the sidelink feedback channel associated with the PDSCH. Moreover, when the first UE 605-1 and the second UE 605-2 form a part of a group of UEs associated with a groupcast communication (e.g., the group of UEs 505-1, 505-2, 505-3 described in connection with FIG. 5), the feedback communication (e.g., the NACK communication) may be broadcast on the sidelink feedback channel to each UE in the group of UEs. In some aspects, as shown by reference number 635, the first UE 605-1 may also transmit another feedback communication (e.g., another NACK communication) to the network entity 610 in a PUCCH or the like. In such aspects, the network entity 610 may not release a HARQ process associated with the PDSCH until the network entity 610 receives a corresponding ACK communication, which will described in more detail in connection with reference number 650.

As shown by reference number 640, the first UE 605-1 may receive, from the second UE 605-2, a retransmission of the TB based at least in part on the feedback communication being transmitted in the sidelink feedback channel (e.g., the ePSFCH) that is associated with the PDSCH. More particularly, when the second UE 605-2 receives the feedback communication (e.g., the NACK communication) in the sidelink feedback channel, the second UE 605-2 may identify the feedback communication as being associated with the TB transmitted in the PDSCH based on the configuration associating the sidelink feedback channel with the PDSCH. Accordingly, the second UE 605-2, based at least in part on receiving the feedback communication in the sidelink feedback channel, may retransmit the TB to the first UE 605-1 via the sidelink (e.g., via the PSSCH 420). As described in connection with FIG. 5, doing so may reduce latency and power consumption associated with the retransmission because the first UE 605-1 and the second UE 605-1 may be located nearer to one another than the first UE 605-1 is located to the network entity 610. Moreover, doing so may free resources on the access link because fewer resources are allocated for retransmissions such as the retransmission of the TB.

As shown by reference number 645 and 650, respectively, if the retransmission described in connection with reference number 640 is successful (e.g., if the retransmitted TB is fully decoded by the first UE 605-1), the first UE 605-1 may transmit an acknowledgement communication (e.g., an ACK message) to the second UE 605-1 and/or may transmit another acknowledgement communication (e.g., another ACK message) to the network entity 610 indicating that the TB has been successfully received. In some aspects, the acknowledgement communication transmitted to the second UE 605-2 may be transmitted on the sidelink feedback channel (e.g., the ePSFCH), while the acknowledgement communication transmitted to the network entity 610 may be transmitted on the PUCCH or the like. In aspects in which the first UE 605-1 transmits the acknowledgement communication to the network entity 610 on the access link (e.g., the PUCCH), the network entity 610 may release the HARQ process associated with the PDSCH once the network entity 610 receives the ACK communication. In this regard, reliability may be improved because the HARQ process remains active until the network entity 610 receives an acknowledgement communication indicating that the TB has been received and decoded. For example, if the network entity 610 does not receive the acknowledgement communication shown by reference number 650 within a certain time period or the like, the network entity 610 may initiate a retransmission of the TB on the access link, ensuring that the first UE 605-1 successfully receives and decodes the TB.

As indicated above, FIG. 6 is provided as an example. Other examples may differ from what is described with respect to FIG. 6.

FIG. 7 is a diagram illustrating an example 700 associated with SPS sidelink feedback channel resources, in accordance with the present disclosure.

In some aspects, the configuration received from the network entity, such as the configuration described in connection with reference number 615, may associate one or more periodically reoccurring sidelink feedback channel resources with one or more periodically reoccurring PDSCH resources. More particularly, in some aspects the configuration may be transmitted using an RRC message or the like that configures SPS PDSCH resources 705, which may include multiple, periodic PDSCH resources 710 (e.g., multiple reoccurring PDSCHs). Moreover, the RRC message or the like may further configure SPS sidelink feedback channel resources 715, which may include multiple, periodic sidelink feedback channel resources 720 (e.g., multiple reoccurring ePSFCHs). In some aspects, the configuration may associate each sidelink feedback channel resource 720 of the SPS sidelink feedback channel resources 715 with a corresponding PDSCH resource 710 of the SPS PDSCH resources 705.

For example, as indicated using arrows in FIG. 7, the configuration may map each sidelink feedback channel resource 720 (e.g., each ePSFCH) to a closest-in-time PDSCH resource 710. More particularly, in the example depicted in FIG. 7, a first sidelink feedback channel resource 720a is mapped to a first PDSCH resource 710a, a second sidelink feedback channel resource 720b is mapped to a second PDSCH resource 710b, a third sidelink feedback channel resource 720c is mapped to a third PDSCH resource 710c, a fourth sidelink feedback channel resource 720d is mapped to a fourth PDSCH resource 710d, a fifth sidelink feedback channel resource 720e is mapped to a fifth PDSCH resource 710e, and a sixth sidelink feedback channel resource 720f is mapped to a sixth PDSCH resource 710f.

Moreover, in some aspects, the network entity 610 may transmit one or more messages activating the configured resources. For example, in some aspects, the network entity 610 may transmit a first message (e.g., an RRC message) configuring the SPS PDSCH resources 705 and/or the SPS sidelink feedback channel resources 715, and may later transmit a second message (e.g., a DCI message, a MAC-CE message, or the like) activating or trigging the SPS PDSCH resources 705 and/or the SPS sidelink feedback channel resources 715. In aspects utilizing the SPS configuration shown in FIG. 7, control overhead may be reduced because a single configuration message (e.g., RRC message) may schedule multiple, reoccurring sidelink feedback channel resources 720, increasing capacity of the access link (e.g., the Uu interface) and improving network efficiency.

In some aspects, each sidelink feedback channel resource 720 may be associated with only a PDSCH resource 710 satisfying a threshold priority value. More particularly, the message configuring the SPS PDSCH resources 705 (e.g., an RRC message or the like) may further indicate a corresponding priority value for each PDSCH resource 710 of the SPS PDSCH resources 705. The message may also configure the SPS sidelink feedback channel resources 715 such that each sidelink feedback channel resource 720 is associated only with high priority PDSCH resources 710 (e.g., PDSCH resources 710 that are associated with a threshold priority value). Thus, in some aspects, less than all of the PDSCH resources 710 will be associated with a corresponding sidelink feedback channel resource 720. In such aspects, the first UE 605-1 and the second UE 605-2 may transmit feedback communications (e.g., NACK communications) in the sidelink (e.g., in the PSSCH 420) and receive retransmissions in the sidelink for high priority PDSCH resources 710 (e.g., for high priority TBs), but may be unable to do so for lower priority PDSCH resources (e.g., for lower priority TBs). Accordingly, mapping sidelink feedback channel resources 720 only to high priority PDSCH resources 710 reduces overhead associated with the sidelink feedback channel, increasing capacity of the sidelink (e.g., the PC5 interface) and improving network efficiency, while still providing a feedback channel for high priority transmissions.

In some aspects, the configuration described in connection with reference numbers 615a and 615b may indicate certain parameters to enable the SPS features described above. For example, with respect to the frequency domain, the configuration may include a parameter indicating a beginning frequency for the SPS sidelink feedback channel resources 715, sometimes referred to as sl-StartPoint-ePSFCH, as well as a parameter indicating a number of continuous subchannels associated with the SPS sidelink feedback channel resources 715, sometimes referred to as sl-NumSubchannel-ePSFCH. And with respect to the time domain, the configuration may include a parameter indicating an offset (e.g., a number of slots) between a beginning slot of each sidelink feedback channel resource 720 and the last slot of the associated PDSCH resource 710, sometimes referred to as sl-Offset-ePSFCH, as well as a parameter indicating a number of continuous slots associated with each sidelink feedback channel resource 720, sometimes referred to as sl-NumSlot-ePSFCH. Additionally, or alternatively, the configuration may indicate an interval (e.g., a number of slots) between adjacent sidelink feedback channel resources 720, sometimes referred to as sl-NumSlot-Period-ePSFCH.

As indicated above, FIG. 7 is provided as an example. Other examples may differ from what is described with respect to FIG. 7.

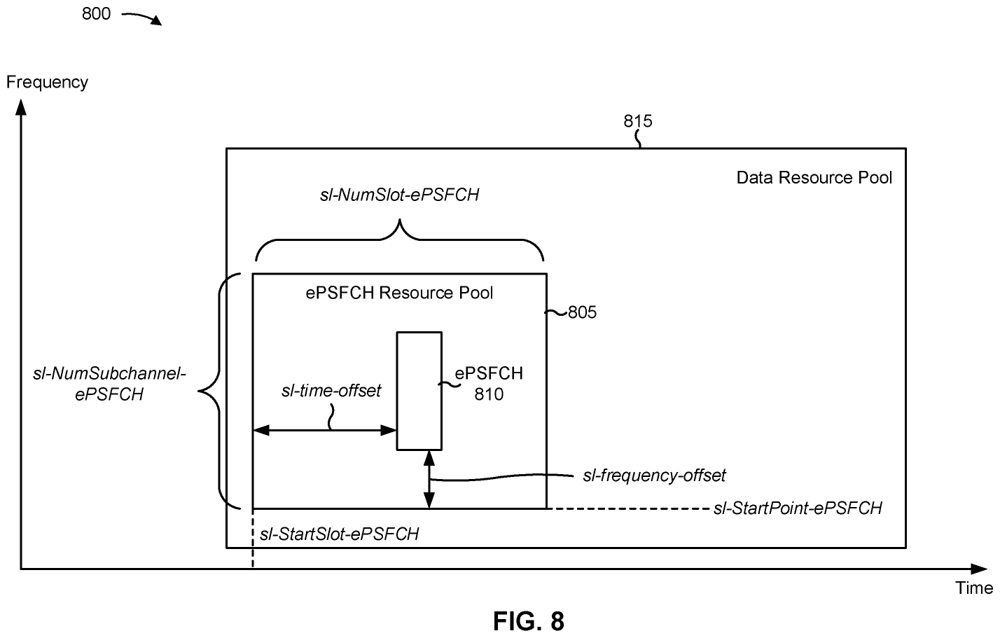

FIG. 8 is a diagram illustrating an example 800 associated with a sidelink feedback channel resource pool, in accordance with the present disclosure.

In some aspects, the sidelink feedback channel may be associated with resources within a sidelink feedback resource pool 805 that is associated with the PDSCH. More particularly, in some aspects, the sidelink feedback resource pool 805 may be associated with a set of time and frequency resources, with the sidelink feedback channel (e.g., the ePSFCH) being associated with a subset of resources 810 of the set of time and frequency resources. In such aspects, the network entity 610 may configure the sidelink feedback resource pool 805 such as by using RRC signaling or the like. More particularly, the configuration transmitted by the network entity 610 at 615a and/or 616b may indicate the resources associated with sidelink feedback resource pool 805 (e.g., may indicate the set of time and frequency resources) via an RRCConnectionReconfiguration parameter. Moreover, the network entity 610 may transmit to the first UE 605-1 and the second UE 605-2 a DCI message or a similar message associated with the PDSCH (e.g., a DCI message that schedules the PDSCH) that indicates the subset of resources 810 of the sidelink feedback resource pool 805 that are associated with the particular PDSCH. For example, the DCI message or similar message may indicate a time offset from a first time resource of the sidelink feedback resource pool 805 to a start of time resources of the subset of resources 810, and the DCI message or similar message may indicate a frequency offset from a first frequency resource of the sidelink feedback resource pool 805 to a start of frequency resources of the subset of resources 810. Additionally, or alternatively, the DCI message or similar message that schedules the PDSCH may also activate the sidelink feedback resource pool 805. In aspects employing the sidelink feedback resource pool 805 features described above, the network entity may reserve certain resources for use by the various UEs to provide feedback in the sidelink, thereby decreasing the probability of interfering or competing communications with the feedback communications and thus resulting in improved reliability and robust retransmission capability.

In some aspects, in addition to providing resources for use as the sidelink feedback channel (e.g., the ePSFCH), the sidelink feedback resource pool 805 also includes resources associated with a PSFCH that is not associated with the PDSCH (e.g., the PSFCH 425). Put another way, in some aspects, the sidelink feedback resource pool 805 is the same resource pool as a PSFCH resource pool, which may reduce control overhead because less singling is used to configure the single resource pool. However, in some other aspects, the sidelink feedback resource pool 805 is separate from resources associated with the PSFCH that is not associated with the PDSCH, thereby increasing a number of dedicated resources provided in the sidelink for transmitting sidelink feedback communications associated with TBs in the PDSCH. In such aspects, the PSFCH that is not associated with the PDSCH may be associated with a subset of resources in a different, PSFCH-specific resource pool.

In some aspects, when the sidelink feedback resource pool 805 is separate from a PSFCH-specific resource pool, rather than receiving a configuration of the subset of resources 810, a UE 605 sending a feedback communication may freely occupy subchannels within the sidelink feedback resource pool 805 for transmitting a feedback communication (e.g., a NACK communication). For example, the subset of resources 810 used to send the feedback communication may be randomly selected from the sidelink feedback resource pool 805 by the first UE 605-1. This may reduce control overhead associated with the sidelink feedback channel because there is no need for a message (e.g., a DCI message or the like) separate from an initial configuration message (e.g., an RRC message or the like) indicating the specific resources to be used for the feedback communication.

Additionally, or alternatively, when the sidelink feedback resource pool 805 is separate from a PSFCH-specific resource pool, the sidelink feedback resource pool 805 may be contained within a data resource pool 815 associated with the sidelink. That is, the configuration shown at reference numbers 615a and 615b may configure certain sidelink data resources for use as the sidelink feedback resource pool 805. This may beneficially reduce the possibility of interference of any feedback communications to be transmitted, because the data resource pool 815 may already be reserved for use by the first UE 605-1 and/or the second UE 605-2.

In some aspects, the configuration described in connection with reference numbers 615a and 615b may indicate certain parameters to enable the sidelink feedback channel resource pool features described above. First, with respect to the sidelink feedback resource pool 805, an RRC message may include a parameter indicating a beginning frequency for the sidelink feedback resource pool 805 (e.g., sl-StartPoint-ePSFCH), a parameter indicating a number of continuous subchannels associated with the sidelink feedback resource pool 805 (e.g., sl-NumSubchannel-ePSFCH), a parameter indicating a beginning slot for the sidelink feedback resource pool 805 (sometimes referred to as sl-StartSlot-ePSFCH), and a parameter indicating a number of continuous slots associated with the sidelink feedback resource pool 805 (e.g., sl-NumSlot-ePSFCH). With respect to the subset of resources 810 associated with the PDSCH, additional signaling, such as a DCI message or the like, may include a parameter indicating a frequency offset (e.g., a number of physical resource blocks (PRBs)) relative to a beginning frequency for the sidelink feedback resource pool 805 at which the subset of resources 810 begin (sometimes referred to as sl-frequency-offset), and may include a parameter indicating a time offset (e.g., a number of slots) relative to a beginning slot for the sidelink feedback resource pool 805 at which the subset of resources 810 begin (sometimes referred to as sl-time-offset).

As indicated above, FIG. 8 is provided as an example. Other examples may differ from what is described with respect to FIG. 8.

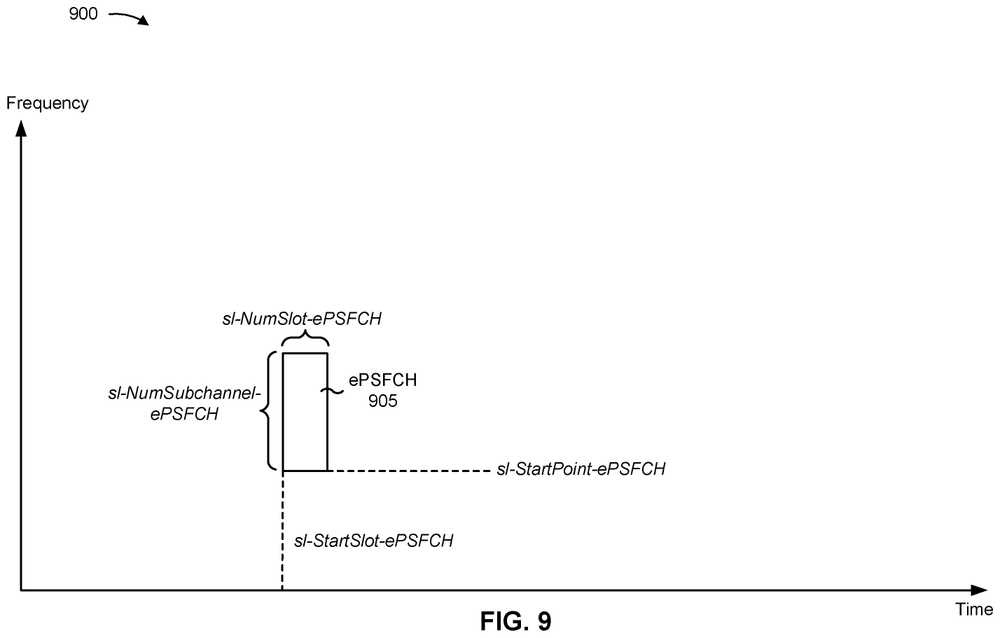

FIG. 9 is a diagram illustrating an example 900 associated with resource allocation for a sidelink feedback channel, in accordance with the present disclosure.

In some aspects, absolute resources (e.g., resources that are not indicated relative to another set of resources) associated with the sidelink feedback channel, as shown by reference number 905, may be indicated by a DCI message or the like that schedules the associated PDSCH communication. Put another way, rather than configuring SPS sidelink feedback channel resources (e.g., the SPS sidelink feedback channel resources 715, or the like) or a sidelink feedback channel resource pool (e.g., the sidelink feedback resource pool 805, or the like) using RRC signaling or similar signaling, in the scheduling DCI for the PDSCH the network entity 610 may indicate an absolute location of associated sidelink feedback channel resources (e.g., a set of ePSFCH resources) that are available for providing sidelink feedback communications related to that PDSCH. In that regard, the DCI message or the like may include a frequency domain resource assignment (FDRA) associated with the sidelink feedback channel and a time domain resource assignment (TDRA) associated with the sidelink feedback channel. Indicating an absolute location of sidelink feedback channel resources associated with a particular PDSCH in a DCI message or the like beneficially provides flexibility in scheduling the sidelink feedback channel, thus reducing the possibility of any feedback communications colliding with other sidelink communications and improving reliability of the sidelink retransmission scheme.

In some aspects, the configuration described in connection with reference numbers 615a and 615b may indicate certain parameters to enable the sidelink feedback channel resource features described above. First, with respect to the frequency domain, a DCI message or the like may include a parameter indicating a beginning frequency for the sidelink feedback channel resources (e.g., sl-StartPoint-ePSFCH), and a parameter indicating a number of continuous subchannels associated with the sidelink feedback channel resources (e.g., sl-NumSubchannel-ePSFCH). Put another way, the FDRA may be indicated using an sl-StartPoint-ePSFCH and an sl-NumSubchannel-ePSFCH parameter. With respect to the time domain, a DCI message or the like may include a parameter indicating a beginning slot for the sidelink feedback channel resources (e.g., sl-StartSlot-ePSFCH), and a parameter indicating a number of continuous slots associated with the sidelink feedback channel resources (e.g., sl-NumSlot-ePSFCH). Put another way, the TDRA may be indicated using an sl-StartSlot-ePSFCH and an sl-NumSlot-ePSFCH parameter.

As indicated above, FIG. 9 is provided as an example. Other examples may differ from what is described with respect to FIG. 9.

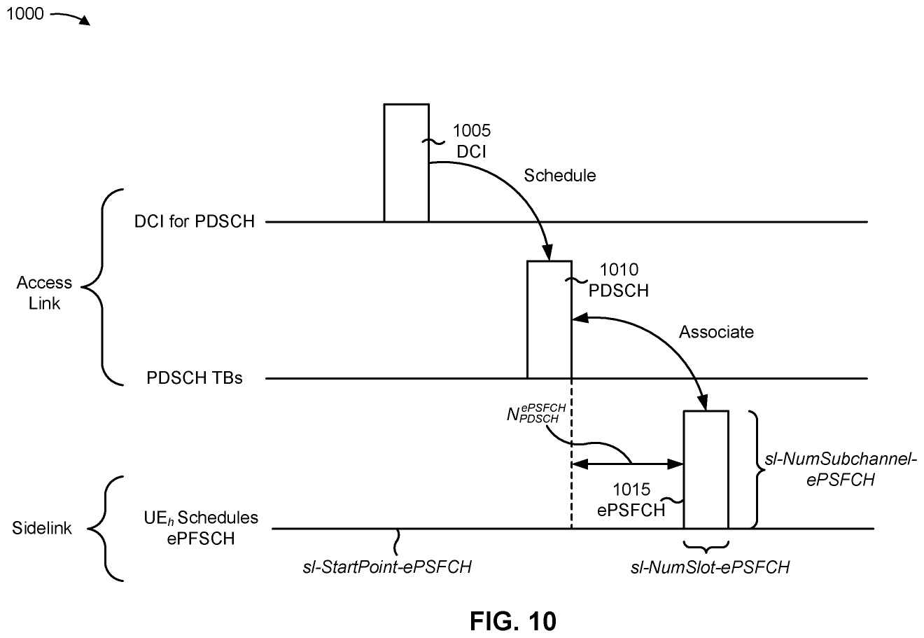

FIG. 10 is a diagram illustrating an example 1000 associated with resource allocation for a sidelink feedback channel, in accordance with the present disclosure.

In some aspects, as described in connection with reference number 620, one of the UEs 605 (e.g., a head UE, or UEh) may transmit the configuration associating the sidelink feedback channel with the PDSCH. More particularly, as shown in FIG. 10, the network entity 610 may transmit a DCI message 1005 or a similar communication that schedules a PDSCH 1010 for transmitting a TB. In this regard, the DCI message 1005 and the PDSCH 1010 may be transmitted on the access link (e.g., the Uu interface). Moreover, one of the first UE 605-1, the second UE 605-2, or another UE, which is designated as the head UE (e.g., UEh), may schedule a sidelink feedback channel 1015 (e.g., an ePSFCH) that is associated with the PDSCH 1010. More particularly, in some aspects, the first UE 605-1 may receive, from another UE (e.g., the head UE such as the second UE 605-2 or another UE) via an SCI message (e.g., SCI 430 or the like), a configuration associating the sidelink feedback channel 1015 with the PDSCH 1010, with the SCI message being transmitted in response to the head UE receiving the DCI message 1005 scheduling the PDSCH 1010. Beneficially, scheduling the sidelink feedback channel 1015 on the sidelink via an SCI message or the like reduces control overhead on the access link because the network entity 610 avoids scheduling the sidelink feedback channel 1015. Moreover, scheduling the sidelink feedback channel 1015 on the sidelink via an SCI or the like may improve reliability of the sidelink feedback communications, because the head UE may be configured with other resource reservations on the sidelink and thus may avoid scheduling the sidelink feedback channel on occupied resources.

In some aspects, the configuration described in connection with reference number 620 may indicate certain parameters to associate the sidelink feedback channel and the PDSCH to enable the sidelink feedback channel resource features described above. First, with respect to the frequency domain, an SCI message (e.g., SCI 430) or the like may include a parameter indicating a beginning frequency for the sidelink feedback channel resources (e.g., sl-StartPoint-ePSFCH), and a parameter indicating a number of continuous subchannels associated with the sidelink feedback channel resources (e.g., sl-NumSubchannel-ePSFCH). With respect to the time domain, the SCI message or the like may include a parameter indicating an interval (e.g., a number of slots) between the a last slot of the PDSCH 1010 and a first slot of the sidelink feedback channel 1015 (sometimes referred to as N_{PDSCH}^{ePSEG}), and a parameter indicating a number of continuous slots associated with the sidelink feedback channel 1015 (e.g., sl-NumSlot-ePSFCH).

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120, UE 405-1, UE 405-2, UE 505-1, UE 505-2, UE 505-3, UE 605-1, UE 605-2) performs operations associated with sidelink retransmission of an access link transport block.

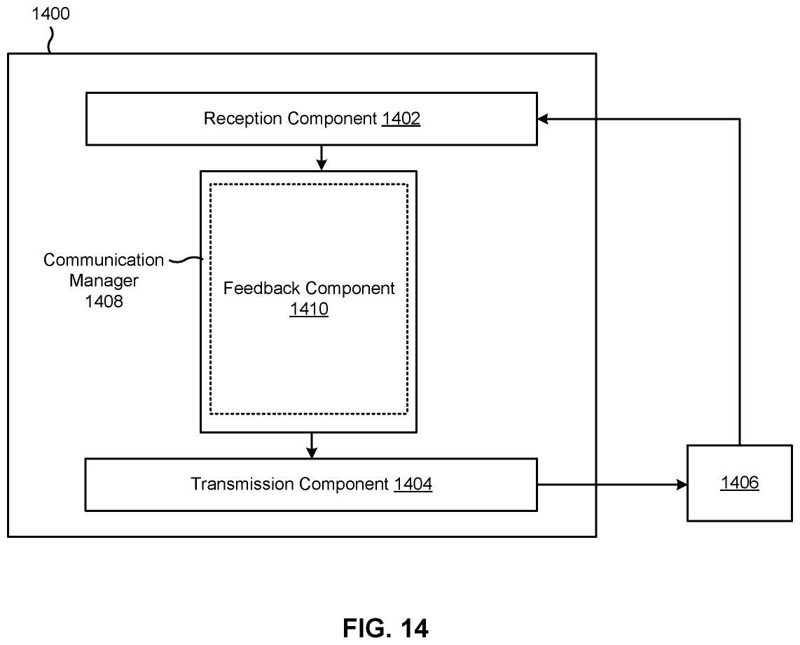

As shown in FIG. 11, in some aspects, process 1100 may include transmitting, to another UE via a sidelink, a feedback communication associated with a transport block in a PDSCH, wherein the feedback communication is transmitted via a sidelink feedback channel that is associated with the PDSCH (block 1110). For example, the UE (e.g., using communication manager 1408 and/or transmission component 1404, depicted in FIG. 14) may transmit, to another UE via a sidelink, a feedback communication associated with a transport block in a PDSCH, wherein the feedback communication is transmitted via a sidelink feedback channel that is associated with the PDSCH, as described above.

As further shown in FIG. 11, in some aspects, process 1100 may include receiving, from the other UE, a retransmission of the transport block based at least in part on the feedback communication being transmitted in the sidelink feedback channel that is associated with the PDSCH (block 1120). For example, the UE (e.g., using communication manager 1408 and/or reception component 1402, depicted in FIG. 14) may receive, from the other UE, a retransmission of the transport block based at least in part on the feedback communication being transmitted in the sidelink feedback channel that is associated with the PDSCH, as described above.

Process 1100 may include additional aspects, such as any single aspect or any combination of aspects described below and/or in connection with one or more other processes described elsewhere herein.

In a first aspect, the UE and the other UE are in wireless communication with a network entity that transmitted the transport block via a groupcast communication, and the PDSCH is associated with the groupcast communication.

In a second aspect, alone or in combination with the first aspect, process 1100 includes transmitting another feedback communication in a PUCCH to a network entity that transmitted the transport block.

In a third aspect, alone or in combination with one or more of the first and second aspects, process 1100 includes transmitting an acknowledgment message to the other UE via the sidelink feedback channel based at least in part on receiving the retransmission of the transport block, and transmitting another acknowledgment message to the network entity via the PUCCH based at least in part on receiving the retransmission of the transport block.

In a fourth aspect, alone or in combination with one or more of the first through third aspects, process 1100 includes receiving, from a network entity, a configuration associating the sidelink feedback channel with the PDSCH.

In a fifth aspect, alone or in combination with one or more of the first through fourth aspects, the PDSCH is associated with one PDSCH resource of multiple SPS PDSCH resources, the sidelink feedback channel is associated with one sidelink feedback channel resource of multiple SPS sidelink feedback channel resources, and the configuration associates each of the multiple SPS sidelink feedback channel resources with a corresponding PDSCH resource of the multiple SPS PDSCH resources.

In a sixth aspect, alone or in combination with one or more of the first through fifth aspects, process 1100 includes receiving, from the network entity, a DCI message or a MAC-CE message activating the multiple SPS sidelink feedback channel resources.

In a seventh aspect, alone or in combination with one or more of the first through sixth aspects, each of the multiple SPS PDSCH resources is associated with a priority value, and the configuration associates each of the multiple SPS sidelink feedback channel resources with a PDSCH resource associated with a corresponding priority value that exceeds a priority value threshold.

In an eighth aspect, alone or in combination with one or more of the first through seventh aspects, the configuration further configures a sidelink feedback resource pool, and the sidelink feedback channel is associated with a subset of resources of the sidelink feedback resource pool.

In a ninth aspect, alone or in combination with one or more of the first through eighth aspects, the sidelink feedback resource pool includes resources associated with a PSFCH that is not associated with the PDSCH.

In a tenth aspect, alone or in combination with one or more of the first through ninth aspects, the sidelink feedback resource pool is separate from resources associated with a PSFCH that is not associated with the PDSCH.

In an eleventh aspect, alone or in combination with one or more of the first through tenth aspects, process 1100 includes receiving, from the network entity, a DCI message including an indication of the subset of resources.

In a twelfth aspect, alone or in combination with one or more of the first through eleventh aspects, the indication of the subset of resources indicates a time offset parameter and a frequency offset parameter, the time offset parameter indicates a time offset from a first time resource of the sidelink feedback resource pool to a start of time resources of the subset of resources, and the frequency offset parameter indicates a frequency offset from a first frequency resource of the sidelink feedback resource pool to a start of frequency resources of the subset of resources.

In a thirteenth aspect, alone or in combination with one or more of the first through twelfth aspects, the sidelink feedback resource pool is within a data resource pool associated with the sidelink.

In a fourteenth aspect, alone or in combination with one or more of the first through thirteenth aspects, process 1100 includes receiving, from the network entity, a DCI message scheduling the PDSCH, wherein the DCI message activates the sidelink feedback resource pool.

In a fifteenth aspect, alone or in combination with one or more of the first through fourteenth aspects, the subset of resources are randomly selected from the sidelink feedback resource pool by the UE.

In a sixteenth aspect, alone or in combination with one or more of the first through fifteenth aspects, process 1100 includes receiving, from the network entity, a DCI message scheduling the PDSCH, wherein the DCI message indicates resources associated with the sidelink feedback channel.

In a seventeenth aspect, alone or in combination with one or more of the first through sixteenth aspects, the DCI message includes an FDRA associated with the sidelink feedback channel and a TDRA associated with the sidelink feedback channel.

In an eighteenth aspect, alone or in combination with one or more of the first through seventeenth aspects, process 1100 includes receiving, from the other UE via an SCI message, a configuration associating the sidelink feedback channel with the PDSCH.

In a nineteenth aspect, alone or in combination with one or more of the first through eighteenth aspects, the SCI message is transmitted in response to the other UE receiving a DCI message scheduling the PDSCH.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated with sidelink retransmission of an access link transport block.

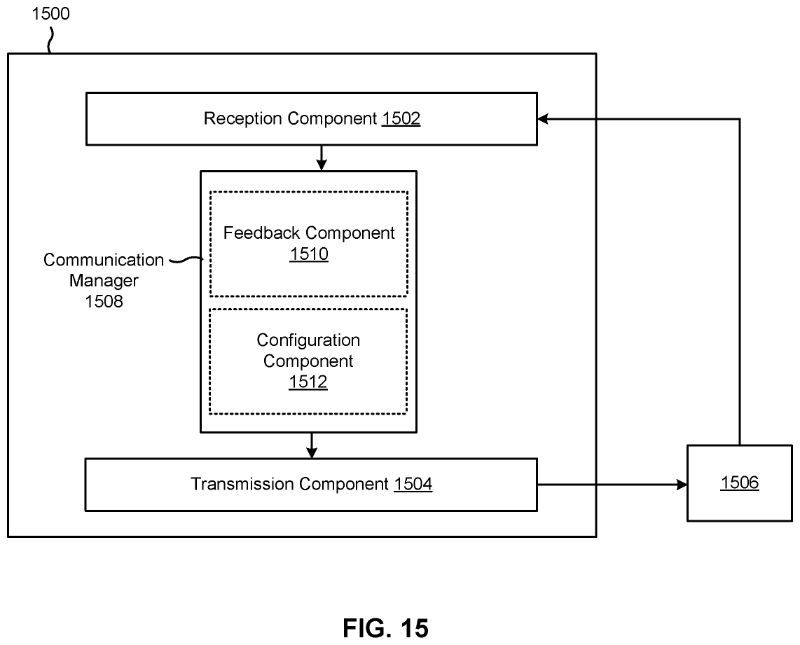

As shown in FIG. 12, in some aspects, process 1200 may include receiving, from another UE via a sidelink, a feedback communication associated with a transport block in a PDSCH, wherein the feedback communication is transmitted via a sidelink feedback channel that is associated with the PDSCH (block 1210). For example, the UE (e.g., using communication manager 1508 and/or reception component 1502, depicted in FIG. 15) may receive, from another UE via a sidelink, a feedback communication associated with a transport block in a PDSCH, wherein the feedback communication is transmitted via a sidelink feedback channel that is associated with the PDSCH, as described above.

As further shown in FIG. 12, in some aspects, process 1200 may include transmitting, to the other UE, a retransmission of the transport block based at least in part on receiving the feedback communication in the sidelink feedback channel that is associated with the PDSCH (block 1220). For example, the UE (e.g., using communication manager 1508 and/or transmission component 1504, depicted in FIG. 15) may transmit, to the other UE, a retransmission of the transport block based at least in part on receiving the feedback communication in the sidelink feedback channel that is associated with the PDSCH, as described above.

Process 1200 may include additional aspects, such as any single aspect or any combination of aspects described below and/or in connection with one or more other processes described elsewhere herein.

In a first aspect, the UE and the other UE are in wireless communication with a network entity that transmitted the transport block via a groupcast communication, and the PDSCH is associated with the groupcast communication.

In a second aspect, alone or in combination with the first aspect, process 1200 includes receiving an acknowledgment message from the other UE via the sidelink feedback channel.

In a third aspect, alone or in combination with one or more of the first and second aspects, process 1200 includes receiving, from a network entity, a configuration associating the sidelink feedback channel with the PDSCH.

In a fourth aspect, alone or in combination with one or more of the first through third aspects, the PDSCH is associated with one PDSCH resource of multiple SPS PDSCH resources, the sidelink feedback channel is associated with one sidelink feedback channel resource of multiple SPS sidelink feedback channel resources, and the configuration associates each of the multiple SPS sidelink feedback channel resources with a corresponding PDSCH resource of the multiple SPS PDSCH resources.

In a fifth aspect, alone or in combination with one or more of the first through fourth aspects, process 1200 includes receiving, from the network entity, a DCI message or a MAC-CE message activating the multiple SPS sidelink feedback channel resources.

In a sixth aspect, alone or in combination with one or more of the first through fifth aspects, each of the multiple SPS PDSCH resources is associated with a priority value, and the configuration associates each of the multiple SPS sidelink feedback channel resources with a PDSCH resource associated with a corresponding priority value that exceeds a priority value threshold.

In a seventh aspect, alone or in combination with one or more of the first through sixth aspects, the configuration further configures a sidelink feedback resource pool, and the sidelink feedback channel is associated with a subset of resources of the sidelink feedback resource pool.

In an eighth aspect, alone or in combination with one or more of the first through seventh aspects, the sidelink feedback resource pool includes resources associated with a PSFCH that is not associated with the PDSCH.

In a ninth aspect, alone or in combination with one or more of the first through eighth aspects, the sidelink feedback resource pool is separate from resources associated with a PSFCH that is not associated with the PDSCH.

In a tenth aspect, alone or in combination with one or more of the first through ninth aspects, process 1200 includes receiving, from the network entity, a DCI message including an indication of the subset of resources.

In an eleventh aspect, alone or in combination with one or more of the first through tenth aspects, the indication of the subset of resources indicates a time offset parameter and a frequency offset parameter, the time offset parameter indicates a time offset from a first time resource of the sidelink feedback resource pool to a start of time resources of the subset of resources, and the frequency offset parameter indicates a frequency offset from a first frequency resource of the sidelink feedback resource pool to a start of frequency resources of the subset of resources.

In a twelfth aspect, alone or in combination with one or more of the first through eleventh aspects, the sidelink feedback resource pool is within a data resource pool associated with the sidelink.

In a thirteenth aspect, alone or in combination with one or more of the first through twelfth aspects, process 1200 includes receiving, from the network entity, a DCI message scheduling the PDSCH, wherein the DCI message activates the sidelink feedback resource pool.

In a fourteenth aspect, alone or in combination with one or more of the first through thirteenth aspects, process 1200 includes receiving, from the network entity, a DCI message scheduling the PDSCH, wherein the DCI message indicates resources associated with the sidelink feedback channel.

In a fifteenth aspect, alone or in combination with one or more of the first through fourteenth aspects, the DCI message includes an FDRA associated with the sidelink feedback channel and a TDRA associated with the sidelink feedback channel.

In a sixteenth aspect, alone or in combination with one or more of the first through fifteenth aspects, process 1200 includes transmitting, to the other UE via an SCI message, a configuration associating the sidelink feedback channel with the PDSCH.

In a seventeenth aspect, alone or in combination with one or more of the first through sixteenth aspects, the SCI message is transmitted in response to receiving a DCI message scheduling the PDSCH.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., base station 110, CU 310, DU 330, RU 340, network entity 510, and/or network entity 610) performs operations associated with sidelink retransmission of an access link transport block.

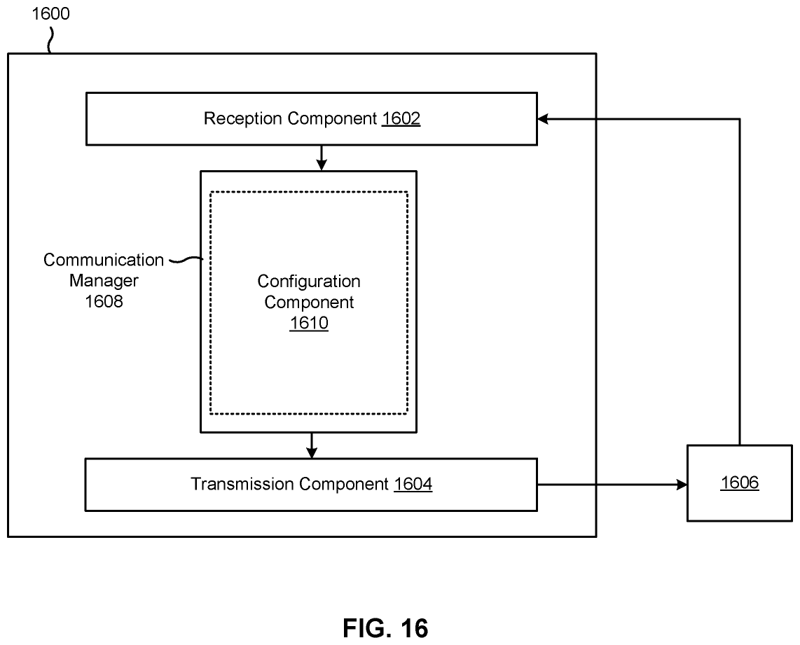

As shown in FIG. 13, in some aspects, process 1300 may include transmitting, to a group of UEs, a transport block in a PDSCH (block 1310). For example, the network entity (e.g., using communication manager 1608 and/or transmission component 1604, depicted in FIG. 16) may transmit, to a group of UEs, a transport block in a PDSCH, as described above.

As further shown in FIG. 13, in some aspects, process 1300 may include transmitting, to the group of UEs, a configuration associating a sidelink feedback channel with the PDSCH (block 1320). For example, the network entity (e.g., using communication manager 1608 and/or transmission component 1604, depicted in FIG. 16) may transmit, to the group of UEs, a configuration associating a sidelink feedback channel with the PDSCH, as described above.

Process 1300 may include additional aspects, such as any single aspect or any combination of aspects described below and/or in connection with one or more other processes described elsewhere herein.

In a first aspect, the group of UEs are in wireless communication with the network entity via a groupcast communication, and the PDSCH is associated with the groupcast communication.

In a second aspect, alone or in combination with the first aspect, the PDSCH is associated with one PDSCH resource of multiple SPS PDSCH resources, the sidelink feedback channel is associated with one sidelink feedback channel resource of multiple SPS sidelink feedback channel resources, and the configuration associates each of the multiple SPS sidelink feedback channel resources with a corresponding PDSCH resource of the multiple SPS PDSCH resources.

In a third aspect, alone or in combination with one or more of the first and second aspects, process 1300 includes transmitting, to the group of UEs, a DCI message or a MAC-CE message activating the multiple SPS sidelink feedback channel resources.

In a fourth aspect, alone or in combination with one or more of the first through third aspects, each of the multiple SPS PDSCH resources is associated with a priority value, and the configuration associates each of the multiple SPS sidelink feedback channel resources with a PDSCH resource associated with a corresponding priority value that exceeds a priority value threshold.

In a fifth aspect, alone or in combination with one or more of the first through fourth aspects, the configuration further configures a sidelink feedback resource pool, and the sidelink feedback channel is associated with a subset of resources of the sidelink feedback resource pool.

In a sixth aspect, alone or in combination with one or more of the first through fifth aspects, the sidelink feedback resource pool includes resources associated with a PSFCH that is not associated with the PDSCH.

In a seventh aspect, alone or in combination with one or more of the first through sixth aspects, the sidelink feedback resource pool is separate from resources associated with a PSFCH that is not associated with the PDSCH.

In an eighth aspect, alone or in combination with one or more of the first through seventh aspects, process 1300 includes transmitting, to the group of UEs, a DCI message including an indication of the subset of resources.

In a ninth aspect, alone or in combination with one or more of the first through eighth aspects, the indication of the subset of resources indicates a time offset parameter and a frequency offset parameter, the time offset parameter indicates a time offset from a first time resource of the sidelink feedback resource pool to a start of time resources of the subset of resources, and the frequency offset parameter indicates a frequency offset from a first frequency resource of the sidelink feedback resource pool to a start of frequency resources of the subset of resources.

In a tenth aspect, alone or in combination with one or more of the first through ninth aspects, the sidelink feedback resource pool is within a data resource pool associated with the sidelink.

In an eleventh aspect, alone or in combination with one or more of the first through tenth aspects, process 1300 includes transmitting, to the group of UEs, a DCI message scheduling the PDSCH, wherein the DCI message activates the sidelink feedback resource pool.

In a twelfth aspect, alone or in combination with one or more of the first through eleventh aspects, process 1300 includes transmitting, to the group of UEs, a DCI message scheduling the PDSCH, wherein the DCI message indicates resources associated with the sidelink feedback channel.

In a thirteenth aspect, alone or in combination with one or more of the first through twelfth aspects, the DCI message includes an FDRA associated with the sidelink feedback channel and a TDRA associated with the sidelink feedback channel.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE (e.g., UE 120, UE 405-1, UE 405-2, UE 505-1, UE 505-2, UE 505-3, UE 605-1, UE 605-2), or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, a network entity, or another wireless communication device) using the reception component 1402 and the transmission component 1404. As further shown, the apparatus 1400 may include the communication manager 1408 (e.g., communication manager 140). The communication manager 1408 may include a feedback component 1410, among other examples.

In some aspects, the apparatus 1400 may be configured to perform one or more operations described herein in connection with FIGS. 6-10. Additionally, or alternatively, the apparatus 1400 may be configured to perform one or more processes described herein, such as process 1100 of FIG. 11. In some aspects, the apparatus 1400 and/or one or more components shown in FIG. 14 may include one or more components of the UE 120 described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The transmission component 1404 and/or the feedback component 1410 may transmit, to another UE via a sidelink, a feedback communication associated with a transport block in a PDSCH, wherein the feedback communication is transmitted via a sidelink feedback channel that is associated with the PDSCH. The reception component 1402 may receive, from the other UE, a retransmission of the transport block based at least in part on the feedback communication being transmitted in the sidelink feedback channel that is associated with the PDSCH.

The transmission component 1404 and/or the feedback component 1410 may transmit another feedback communication in a PUCCH to a network entity that transmitted the transport block.

The transmission component 1404 and/or the feedback component 1410 may transmit an acknowledgment message to the other UE via the sidelink feedback channel based at least in part on receiving the retransmission of the transport block.

The transmission component 1404 and/or the feedback component 1410 may transmit another acknowledgment message to the network entity via the PUCCH based at least in part on receiving the retransmission of the transport block.

The reception component 1402 may receive, from a network entity, a configuration associating the sidelink feedback channel with the PDSCH.

The reception component 1402 may receive, from the network entity, a DCI message or a MAC-CE message activating the multiple SPS sidelink feedback channel resources.

The reception component 1402 may receive, from the network entity, a DCI message including an indication of the subset of resources.

The reception component 1402 may receive, from the network entity, a DCI message scheduling the PDSCH, wherein the DCI message activates the sidelink feedback resource pool.

The reception component 1402 may receive, from the network entity, a DCI message scheduling the PDSCH wherein the DCI message indicates resources associated with the sidelink feedback channel.

The reception component 1402 may receive, from the other UE via a SCI message, a configuration associating the sidelink feedback channel with the PDSCH.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a UE (e.g., UE 120, UE 405-1, UE 405-2, UE 505-1, UE 505-2, UE 505-3, UE 605-1, UE 605-2), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 1508 (e.g., communication manager 140). The communication manager 1508 may include a feedback component 1510 or a configuration component 1512, among other examples.

In some aspects, the apparatus 1500 may be configured to perform one or more operations described herein in connection with FIGS. 6-10. Additionally, or alternatively, the apparatus 1500 may be configured to perform one or more processes described herein, such as process 1200 of FIG. 12. In some aspects, the apparatus 1500 and/or one or more components shown in FIG. 15 may include one or more components of the UE 120 described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 and/or the feedback component 1510 may receive, from another UE via a sidelink, a feedback communication associated with a transport block in a PDSCH wherein the feedback communication is transmitted via a sidelink feedback channel that is associated with the PDSCH. The transmission component 1504 may transmit, to the other UE, a retransmission of the transport block based at least in part on receiving the feedback communication in the sidelink feedback channel that is associated with the PDSCH.

The reception component 1502 and/or the feedback component 1510 may receive an acknowledgment message from the other UE via the sidelink feedback channel.

The reception component 1502 may receive, from a network entity, a configuration associating the sidelink feedback channel with the PDSCH.

The reception component 1502 may receive, from the network entity, a DCI message or a MAC-CE message activating the multiple SPS sidelink feedback channel resources.

The reception component 1502 may receive, from the network entity, a DCI message including an indication of the subset of resources.

The reception component 1502 may receive, from the network entity, a DCI message scheduling the PDSCH, wherein the DCI message activates the sidelink feedback resource pool.

The reception component 1502 may receive, from the network entity, a DCI message scheduling the PDSCH, wherein the DCI message indicates resources associated with the sidelink feedback channel.

The transmission component 1504 and/or the configuration component 1512 may transmit, to the other UE via a SCI message, a configuration associating the sidelink feedback channel with the PDSCH.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network entity (e.g., base station 110, CU 310, DU 330, RU 340, network entity 510, network entity 610, or a similar network entity) or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608 (e.g., communication manager 150). The communication manager 1608 may include a configuration component 1610, among other examples.

In some aspects, the apparatus 1600 may be configured to perform one or more operations described herein in connection with FIGS. 6-10. Additionally, or alternatively, the apparatus 1600 may be configured to perform one or more processes described herein, such as process 1300 of FIG. 13. In some aspects, the apparatus 1600 and/or one or more components shown in FIG. 16 may include one or more components of the base station 110 described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The transmission component 1604 may transmit, to a group of UEs, a transport block in a PDSCH. The transmission component 1604 and/or the configuration component 1610 may transmit, to the group of UEs, a configuration associating a sidelink feedback channel with the PDSCH.

The transmission component 1604 and/or the configuration component 1610 may transmit, to the group of UEs, a DCI message or a MAC-CE message activating the multiple SPS sidelink feedback channel resources.

The transmission component 1604 and/or the configuration component 1610 may transmit, to the group of UEs, a DCI message including an indication of the subset of resources.

The transmission component 1604 and/or the configuration component 1610 may transmit, to the group of UEs, a DCI message scheduling the PDSCH, wherein the DCI message activates the sidelink feedback resource pool.

The transmission component 1604 and/or the configuration component 1610 may transmit, to the group of UEs, a DCI message scheduling the PDSCH, wherein the DCI message indicates resources associated with the sidelink feedback channel.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a UE, comprising: transmitting, to another UE via a sidelink, a feedback communication associated with a transport block in a PDSCH, wherein the feedback communication is transmitted via a sidelink feedback channel that is associated with the PDSCH; and receiving, from the other UE, a retransmission of the transport block based at least in part on the feedback communication being transmitted in the sidelink feedback channel that is associated with the PDSCH.
Aspect 2: The method of Aspect 1, wherein the UE and the other UE are in wireless communication with a network entity that transmitted the transport block via a groupcast communication, and wherein the PDSCH is associated with the groupcast communication.
Aspect 3: The method of any of Aspects 1-2, further comprising: transmitting another feedback communication in a PUCCH to a network entity that transmitted the transport block.
Aspect 4: The method of Aspect 3, further comprising: transmitting an acknowledgment message to the other UE via the sidelink feedback channel based at least in part on receiving the retransmission of the transport block; and transmitting another acknowledgment message to the network entity via the PUCCH based at least in part on receiving the retransmission of the transport block.
Aspect 5: The method of any of Aspects 1-4, further comprising: receiving, from a network entity, a configuration associating the sidelink feedback channel with the PDSCH.
Aspect 6: The method of Aspect 5, wherein the PDSCH is associated with one PDSCH resource of multiple SPS PDSCH resources, wherein the sidelink feedback channel is associated with one sidelink feedback channel resource of multiple SPS sidelink feedback channel resources, and wherein the configuration associates each of the multiple SPS sidelink feedback channel resources with a corresponding PDSCH resource of the multiple SPS PDSCH resources.
Aspect 7: The method of Aspect 6, further comprising: receiving, from the network entity, a DCI message or a MAC-CE message activating the multiple SPS sidelink feedback channel resources.
Aspect 8: The method of any of Aspects 6-7, wherein each of the multiple SPS PDSCH resources is associated with a priority value, and wherein the configuration associates each of the multiple SPS sidelink feedback channel resources with a PDSCH resource associated with a corresponding priority value that exceeds a priority value threshold.
Aspect 9: The method of Aspect 5, wherein the configuration further configures a sidelink feedback resource pool, and wherein the sidelink feedback channel is associated with a subset of resources of the sidelink feedback resource pool.
Aspect 10: The method of Aspect 9, wherein the sidelink feedback resource pool includes resources associated with a PSFCH that is not associated with the PDSCH.
Aspect 11: The method of Aspect 9, wherein the sidelink feedback resource pool is separate from resources associated with a PSFCH that is not associated with the PDSCH.
Aspect 12: The method of any of Aspects 9-11, further comprising: receiving, from the network entity, a DCI message including an indication of the subset of resources.
Aspect 13: The method of Aspect 12, wherein the indication of the subset of resources indicates a time offset parameter and a frequency offset parameter, wherein the time offset parameter indicates a time offset from a first time resource of the sidelink feedback resource pool to a start of time resources of the subset of resources, and wherein the frequency offset parameter indicates a frequency offset from a first frequency resource of the sidelink feedback resource pool to a start of frequency resources of the subset of resources.
Aspect 14: The method of any of Aspects 9-13, wherein the sidelink feedback resource pool is within a data resource pool associated with the sidelink.
Aspect 15: The method of any of Aspects 9-14, further comprising: receiving, from the network entity, a DCI message scheduling the PDSCH, wherein the DCI message activates the sidelink feedback resource pool.
Aspect 16: The method of Aspect 15, wherein the subset of resources are randomly selected from the sidelink feedback resource pool by the UE.
Aspect 17: The method of Aspect 5, further comprising: receiving, from the network entity, a DCI message scheduling the PDSCH, wherein the DCI message indicates resources associated with the sidelink feedback channel.
Aspect 18: The method of Aspect 17, wherein the DCI message includes an FDRA associated with the sidelink feedback channel and a TDRA associated with the sidelink feedback channel.
Aspect 19: The method of any of Aspects 1-4, further comprising: receiving, from the other UE via an SCI message, a configuration associating the sidelink feedback channel with the PDSCH.
Aspect 20: The method of Aspect 19, wherein the SCI message is transmitted in response to the other UE receiving a DCI message scheduling the PDSCH.
Aspect 21: A method of wireless communication performed by a UE, comprising: receiving, from another UE via a sidelink, a feedback communication associated with a transport block in a PDSCH, wherein the feedback communication is transmitted via a sidelink feedback channel that is associated with the PDSCH; and transmitting, to the other UE, a retransmission of the transport block based at least in part on receiving the feedback communication in the sidelink feedback channel that is associated with the PDSCH.
Aspect 22: The method of Aspect 21, wherein the UE and the other UE are in wireless communication with a network entity that transmitted the transport block via a groupcast communication, and wherein the PDSCH is associated with the groupcast communication.
Aspect 23: The method of any of Aspects 21-22, further comprising: receiving an acknowledgment message from the other UE via the sidelink feedback channel.
Aspect 24: The method of any of Aspects 21-23, further comprising: receiving, from a network entity, a configuration associating the sidelink feedback channel with the PDSCH.
Aspect 25: The method of Aspect 24, wherein the PDSCH is associated with one PDSCH resource of multiple SPS PDSCH resources, wherein the sidelink feedback channel is associated with one sidelink feedback channel resource of multiple SPS sidelink feedback channel resources, and wherein the configuration associates each of the multiple SPS sidelink feedback channel resources with a corresponding PDSCH resource of the multiple SPS PDSCH resources.
Aspect 26: The method of Aspect 25, further comprising: receiving, from the network entity, a DCI message or a MAC-CE message activating the multiple SPS sidelink feedback channel resources.
Aspect 27: The method of any of Aspects 25-26, wherein each of the multiple SPS PDSCH resources is associated with a priority value, and wherein the configuration associates each of the multiple SPS sidelink feedback channel resources with a PDSCH resource associated with a corresponding priority value that exceeds a priority value threshold.
Aspect 28: The method of Aspect 24, wherein the configuration further configures a sidelink feedback resource pool, and wherein the sidelink feedback channel is associated with a subset of resources of the sidelink feedback resource pool.
Aspect 29: The method of Aspect 28, wherein the sidelink feedback resource pool includes resources associated with a PSFCH that is not associated with the PDSCH.
Aspect 30: The method of Aspect 28, wherein the sidelink feedback resource pool is separate from resources associated with a PSFCH that is not associated with the PDSCH.
Aspect 31: The method of any of Aspects 28-30, further comprising: receiving, from the network entity, a DCI message including an indication of the subset of resources.
Aspect 32: The method of Aspect 31, wherein the indication of the subset of resources indicates a time offset parameter and a frequency offset parameter, wherein the time offset parameter indicates a time offset from a first time resource of the sidelink feedback resource pool to a start of time resources of the subset of resources, and wherein the frequency offset parameter indicates a frequency offset from a first frequency resource of the sidelink feedback resource pool to a start of frequency resources of the subset of resources.
Aspect 33: The method of any of Aspects 28-32, wherein the sidelink feedback resource pool is within a data resource pool associated with the sidelink.
Aspect 34: The method of any of Aspects 28-32, further comprising: receiving, from the network entity, a DCI message scheduling the PDSCH, wherein the DCI message activates the sidelink feedback resource pool.
Aspect 35: The method of any of Aspects 24, further comprising: receiving, from the network entity, a DCI message scheduling the PDSCH, wherein the DCI message indicates resources associated with the sidelink feedback channel.
Aspect 36: The method of Aspect 35, wherein the DCI message includes an FDRA associated with the sidelink feedback channel and a TDRA associated with the sidelink feedback channel.
Aspect 37: The method of any of Aspects 21-23, further comprising: transmitting, to the other UE via an SCI message, a configuration associating the sidelink feedback channel with the PDSCH.
Aspect 38: The method of Aspect 37, wherein the SCI message is transmitted in response to receiving a DCI message scheduling the PDSCH.
Aspect 39: A method of wireless communication performed by a network entity, comprising: transmitting, to a group of UEs, a transport block in a PDSCH; and transmitting, to the group of UEs, a configuration associating a sidelink feedback channel with the PDSCH.
Aspect 40: The method of Aspect 39, wherein the group of UEs are in wireless communication with the network entity via a groupcast communication, and wherein the PDSCH is associated with the groupcast communication.
Aspect 41: The method of any of Aspects 39-40, wherein the PDSCH is associated with one PDSCH resource of multiple SPS PDSCH resources, wherein the sidelink feedback channel is associated with one sidelink feedback channel resource of multiple SPS sidelink feedback channel resources, and wherein the configuration associates each of the multiple SPS sidelink feedback channel resources with a corresponding PDSCH resource of the multiple SPS PDSCH resources.
Aspect 42: The method of Aspect 41, further comprising: transmitting, to the group of UEs, a DCI message or a MAC-CE message activating the multiple SPS sidelink feedback channel resources.
Aspect 43: The method of any of Aspects 41-42, wherein each of the multiple SPS PDSCH resources is associated with a priority value, and wherein the configuration associates each of the multiple SPS sidelink feedback channel resources with a PDSCH resource associated with a corresponding priority value that exceeds a priority value threshold.
Aspect 44: The method of any of Aspects 39-40, wherein the configuration further configures a sidelink feedback resource pool, and wherein the sidelink feedback channel is associated with a subset of resources of the sidelink feedback resource pool.
Aspect 45: The method of Aspect 44, wherein the sidelink feedback resource pool includes resources associated with a PSFCH that is not associated with the PDSCH.
Aspect 46: The method of Aspect 44, wherein the sidelink feedback resource pool is separate from resources associated with a PSFCH that is not associated with the PDSCH.
Aspect 47: The method of any of Aspects 44-46, further comprising: transmitting, to the group of UEs, a DCI message including an indication of the subset of resources.
Aspect 48: The method of Aspect 47, wherein the indication of the subset of resources indicates a time offset parameter and a frequency offset parameter, wherein the time offset parameter indicates a time offset from a first time resource of the sidelink feedback resource pool to a start of time resources of the subset of resources, and wherein the frequency offset parameter indicates a frequency offset from a first frequency resource of the sidelink feedback resource pool to a start of frequency resources of the subset of resources.
Aspect 49: The method of any of Aspects 44-47, wherein the sidelink feedback resource pool is within a data resource pool associated with the sidelink.
Aspect 50: The method of any of Aspects 44-48, further comprising: transmitting, to the group of UEs, a DCI message scheduling the PDSCH, wherein the DCI message activates the sidelink feedback resource pool.
Aspect 51: The method of any of Aspects 39-40, further comprising: transmitting, to the group of UEs, a DCI message scheduling the PDSCH, wherein the DCI message indicates resources associated with the sidelink feedback channel.
Aspect 52: The method of Aspect 51, wherein the DCI message includes an FDRA associated with the sidelink feedback channel and a TDRA associated with the sidelink feedback channel.
Aspect 53: An apparatus for wireless communication at a device, comprising a processor; memory coupled with the processor; and instructions stored in the memory and executable by the processor to cause the apparatus to perform the method of one or more of Aspects 1-20.
Aspect 54: A device for wireless communication, comprising a memory and one or more processors coupled to the memory, the one or more processors configured to perform the method of one or more of Aspects 1-20.
Aspect 55: An apparatus for wireless communication, comprising at least one means for performing the method of one or more of Aspects 1-20.
Aspect 56: A non-transitory computer-readable medium storing code for wireless communication, the code comprising instructions executable by a processor to perform the method of one or more of Aspects 1-20.
Aspect 57: A non-transitory computer-readable medium storing a set of instructions for wireless communication, the set of instructions comprising one or more instructions that, when executed by one or more processors of a device, cause the device to perform the method of one or more of Aspects 1-20.
Aspect 58: An apparatus for wireless communication at a device, comprising a processor; memory coupled with the processor; and instructions stored in the memory and executable by the processor to cause the apparatus to perform the method of one or more of Aspects 21-38.
Aspect 59: A device for wireless communication, comprising a memory and one or more processors coupled to the memory, the one or more processors configured to perform the method of one or more of Aspects 21-38.
Aspect 60: An apparatus for wireless communication, comprising at least one means for performing the method of one or more of Aspects 21-38.
Aspect 61: A non-transitory computer-readable medium storing code for wireless communication, the code comprising instructions executable by a processor to perform the method of one or more of Aspects 21-38.
Aspect 62: A non-transitory computer-readable medium storing a set of instructions for wireless communication, the set of instructions comprising one or more instructions that, when executed by one or more processors of a device, cause the device to perform the method of one or more of Aspects 21-38.
Aspect 63: An apparatus for wireless communication at a device, comprising a processor; memory coupled with the processor; and instructions stored in the memory and executable by the processor to cause the apparatus to perform the method of one or more of Aspects 39-52.
Aspect 64: A device for wireless communication, comprising a memory and one or more processors coupled to the memory, the one or more processors configured to perform the method of one or more of Aspects 39-52.
Aspect 65: An apparatus for wireless communication, comprising at least one means for performing the method of one or more of Aspects 39-52.
Aspect 66: A non-transitory computer-readable medium storing code for wireless communication, the code comprising instructions executable by a processor to perform the method of one or more of Aspects 39-52.
Aspect 67: A non-transitory computer-readable medium storing a set of instructions for wireless communication, the set of instructions comprising one or more instructions that, when executed by one or more processors of a device, cause the device to perform the method of one or more of Aspects 39-52.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to another UE via a sidelink, a feedback communication associated with a transport block in a physical downlink shared channel (PDSCH),
wherein the feedback communication is transmitted via a sidelink feedback channel that is associated with the PDSCH; and
receive, from the other UE, a retransmission of the transport block based at least in part on the feedback communication being transmitted in the sidelink feedback channel that is associated with the PDSCH.

2. The apparatus of claim 1, wherein the UE and the other UE are in wireless communication with a network entity that transmitted the transport block via a groupcast communication, and
wherein the PDSCH is associated with the groupcast communication.

3. The apparatus of claim 1, wherein the one or more processors are further configured to:
receive, from a network entity, a configuration associating the sidelink feedback channel with the PDSCH.

4. The apparatus of claim 3, wherein the PDSCH is associated with one PDSCH resource of multiple semi-persistently scheduled (SPS) PDSCH resources,
wherein the sidelink feedback channel is associated with one sidelink feedback channel resource of multiple SPS sidelink feedback channel resources, and
wherein the configuration associates each of the multiple SPS sidelink feedback channel resources with a corresponding PDSCH resource of the multiple SPS PDSCH resources.

5. The apparatus of claim 4, wherein each of the multiple SPS PDSCH resources is associated with a priority value, and
wherein the configuration associates each of the multiple SPS sidelink feedback channel resources with a PDSCH resource associated with a corresponding priority value that exceeds a priority value threshold.

6. The apparatus of claim 3, wherein the configuration further configures a sidelink feedback resource pool, and
wherein the sidelink feedback channel is associated with a subset of resources of the sidelink feedback resource pool.

7. The apparatus of claim 6, wherein the one or more processors are further configured to:
receive, from the network entity, a downlink control information (DCI) message including an indication of the subset of resources.

8. The apparatus of claim 7, wherein the indication of the subset of resources indicates a time offset parameter and a frequency offset parameter,
wherein the time offset parameter indicates a time offset from a first time resource of the sidelink feedback resource pool to a start of time resources of the subset of resources, and
wherein the frequency offset parameter indicates a frequency offset from a first frequency resource of the sidelink feedback resource pool to a start of frequency resources of the subset of resources.

9. The apparatus of claim 6, wherein the one or more processors are further configured to:
receive, from the network entity, a downlink control information (DCI) message scheduling the PDSCH, wherein the DCI message activates the sidelink feedback resource pool.

10. The apparatus of claim 9, wherein the subset of resources are randomly selected from the sidelink feedback resource pool by the UE.

11. The apparatus of claim 3, wherein the one or more processors are further configured to:
receive, from the network entity, a downlink control information (DCI) message scheduling the PDSCH,
wherein the DCI message indicates resources associated with the sidelink feedback channel.

12. The apparatus of claim 11, wherein the DCI message includes a frequency domain resource assignment (FDRA) associated with the sidelink feedback channel and a time domain resource assignment (TDRA) associated with the sidelink feedback channel.

13. The apparatus of claim 1, wherein the one or more processors are further configured to:
receive, from the other UE via a sidelink control information (SCI) message, a configuration associating the sidelink feedback channel with the PDSCH.

14. An apparatus for wireless communication at a UE, comprising:
a memory; and
one or more processors, coupled to the memory, configured to:
receive, from another UE via a sidelink, a feedback communication associated with a transport block in a physical downlink shared channel (PDSCH),
wherein the feedback communication is transmitted via a sidelink feedback channel that is associated with the PDSCH; and
transmit, to the other UE, a retransmission of the transport block based at least in part on receiving the feedback communication in the sidelink feedback channel that is associated with the PDSCH.

15. The apparatus of claim 14, wherein the UE and the other UE are in wireless communication with a network entity that transmitted the transport block via a groupcast communication, and
wherein the PDSCH is associated with the groupcast communication.

16. The apparatus of claim 14, wherein the one or more processors are further configured to:
receive, from a network entity, a configuration associating the sidelink feedback channel with the PDSCH.

17. The apparatus of claim 16, wherein the PDSCH is associated with one PDSCH resource of multiple semi-persistently scheduled (SPS) PDSCH resources,
wherein the sidelink feedback channel is associated with one sidelink feedback channel resource of multiple SPS sidelink feedback channel resources, and
wherein the configuration associates each of the multiple SPS sidelink feedback channel resources with a corresponding PDSCH resource of the multiple SPS PDSCH resources.

18. The apparatus of claim 17, wherein each of the multiple SPS PDSCH resources is associated with a priority value, and
wherein the configuration associates each of the multiple SPS sidelink feedback channel resources with a PDSCH resource associated with a corresponding priority value that exceeds a priority value threshold.

19. The apparatus of claim 16, wherein the configuration further configures a sidelink feedback resource pool, and
wherein the sidelink feedback channel is associated with a subset of resources of the sidelink feedback resource pool.

20. The apparatus of claim 19, wherein the one or more processors are further configured to:
receive, from the network entity, a downlink control information (DCI) message including an indication of the subset of resources.

21. The apparatus of claim 20, wherein the indication of the subset of resources indicates a time offset parameter and a frequency offset parameter,
wherein the time offset parameter indicates a time offset from a first time resource of the sidelink feedback resource pool to a start of time resources of the subset of resources, and
wherein the frequency offset parameter indicates a frequency offset from a first frequency resource of the sidelink feedback resource pool to a start of frequency resources of the subset of resources.

22. The apparatus of claim 16, wherein the one or more processors are further configured to:
receive, from the network entity, a downlink control information (DCI) message scheduling the PDSCH, wherein the DCI message indicates resources associated with the sidelink feedback channel.

23. The apparatus of claim 22, wherein the DCI message includes a frequency domain resource assignment (FDRA) associated with the sidelink feedback channel and a time domain resource assignment (TDRA) associated with the sidelink feedback channel.

24. The apparatus of claim 14, wherein the one or more processors are further configured to:
transmit, to the other UE via a sidelink control information (SCI) message, a configuration associating the sidelink feedback channel with the PDSCH.

25. An apparatus for wireless communication at a network entity, comprising:
a memory; and
one or more processors, coupled to the memory, configured to:
transmit, to a group of user equipments (UEs), a transport block in a physical downlink shared channel (PDSCH); and
transmit, to the group of UEs, a configuration associating a sidelink feedback channel with the PDSCH.

26. The apparatus of claim 25, wherein the group of UEs are in wireless communication with the network entity via a groupcast communication, and
wherein the PDSCH is associated with the groupcast communication.

27. The apparatus of claim 25, wherein the PDSCH is associated with one PDSCH resource of multiple semi-persistently scheduled (SPS) PDSCH resources,
wherein the sidelink feedback channel is associated with one sidelink feedback channel resource of multiple SPS sidelink feedback channel resources, and
wherein the configuration associates each of the multiple SPS sidelink feedback channel resources with a corresponding PDSCH resource of the multiple SPS PDSCH resources.

28. The apparatus of claim 25, wherein the configuration further configures a sidelink feedback resource pool, and
wherein the sidelink feedback channel is associated with a subset of resources of the sidelink feedback resource pool.

29. A method of wireless communication performed by a user equipment (UE), comprising:
transmitting, to another UE via a sidelink, a feedback communication associated with a transport block in a physical downlink shared channel (PDSCH),
wherein the feedback communication is transmitted via a sidelink feedback channel that is associated with the PDSCH; and
receiving, from the other UE, a retransmission of the transport block based at least in part on the feedback communication being transmitted in the sidelink feedback channel that is associated with the PDSCH.

30. The method of claim 29, further comprising:
receiving, from a network entity, a configuration associating the sidelink feedback channel with the PDSCH.
